(19) United States
(12) Patent Application Publication
(10) Pub. No.: US 2025/0214092 A1
(43) Pub. Date: Jul. 3, 2025

(54) AERATED HYDROCYCLONE APPARATUS AND METHOD FOR CYCLONIC FROTH SEPARATION

(71) Applicants: Hassan Elhady Hassan Mohamed Fayed, Blacksburg, VA (US); Heba Ahmed Elsaid Abdelrahman Elsewidy, Blacksburg, VA (US)

(72) Inventors: Hassan Elhady Hassan Mohamed Fayed, Blacksburg, VA (US); Heba Ahmed Elsaid Abdelrahman Elsewidy, Blacksburg, VA (US)

(21) Appl. No.: 19/082,185

(22) Filed: Mar. 18, 2025

Related U.S. Application Data
(63) Continuation-in-part of application No. 18/154,369, filed on Jan. 13, 2023, now Pat. No. 12,251,718.
Application No. 18/154,369 is a continuation of application No. 17/166,557, filed on Feb. 3, 2021, now Pat. No. 11,583,868.
(60) Provisional application No. 63/062,332, filed on Aug. 6, 2020.

(51) Int. Cl. B04C 5/103; B03D 1/14; B04C 5/081; B04C 5/10; B04C 9/00

(52) U.S. Cl. CPC B04C 5/103; B04C 5/081; B04C 5/10; B03D 1/1425; B04C 2009/008

(57) ABSTRACT

The embodiments disclose a hydrocyclone apparatus for separating particles from a slurry including a central body wall extending from a first opening at one end to a second opening at the opposite end, an air base column coupled to the second opening configured to support the hydrocyclone, at least one slurry from a group of containing water with solid particles, hydrophobic particles, or saltwater particles configured to be flowed into the hydrocyclone apparatus, a first volute coupled to the first opening slurry input port configured to allow slurry to flow from the volute into the central body, an overflow opening coupled to the first opening configured to recover separated water and hydrophobic particles, a second volute coupled to the second opening exhaust port configured to allow slurry to exit the central body, and a plurality of underflow exit openings coupled to the exhaust port that expel particles from the apparatus.

### CROSS REFERENCE TO RELATED PATENTS AND APPLICATIONS

This application is a continuation-in-part of and claims priority to and the benefit of U.S. application Ser. No. 18/154,369 filed Jan. 13, 2023, entitled “AERATED HYDROCYCLONE APPARATUS AND METHOD FOR CYCLONIC FROTH SEPARATION”, by Hassan Elhady Hassan Mohamed Fayed, which is a continuation of and claims priority to and the benefit of U.S. application Ser. No. 17/166,557 filed Feb. 3, 2021, entitled “AERATED HYDROCYCLONE APPARATUS AND METHOD FOR CYCLONIC FROTH SEPARATION”, by Hassan Elhady Hassan Mohamed Fayed, which claims the benefit of U.S. Provisional application Ser. No. 63/062,332, filed Aug. 6, 2020, the U.S. patent applications being incorporated herein by reference.

### FIELD OF THE DISCLOSURE

The present disclosure relates to an aerated hydrocyclone apparatus and method for cyclonic froth separation.

### BACKGROUND

Hydrocyclones for separation of particles and liquids are known however existing devices present issues with clogging of the device during execution of the separation process and relatively high hydrodynamic loss due to unrecovered kinetic energy. A device may perform the particle separation process until the device has been clogged, thereby rendering the device unable to perform separation until user intervention is applied to unclog the device. An apparatus to prevent clogging of the device does not appear to be known in the art.

### SUMMARY

One aspect of the present disclosure relates to an aerated hydrocyclone apparatus to separate particles from a slurry. The apparatus may include a cylindrical central body. The central body may be formed by a body wall. The body wall being hollow and including a first opening on one end of the body wall and a second opening on the end opposite of the first body opening. The central body may include a pressured fluid port. The pressurized fluid port may be configured to receive pressurized gaseous fluid to generate a hydrocyclone within the apparatus.

The central body may house a porous barrier. The porous barrier may run longitudinally from a first primary barrier opening at one end of the porous barrier to a second primary barrier opening at the end opposite of the first primary barrier opening. The porous barrier may be housed in the central body such that the longitudinal axis of the porous barrier is generally parallel to the longitudinal axis of the central body. The porous barrier may include secondary barrier openings.

The second barrier openings may facilitate flows of pressurized gaseous fluid through the porous barrier in directions that have a common directional tangential component. The directions of flow of the pressurized gas may enhance cyclonic motion of the slurry within the interior of the porous barrier. The apparatus may contain a first volute. The first volute may include a first body interface. The first body interface may attach to the first body opening to form a first cyclonic opening. The first cyclonic opening may provide fluid communication between the first volute and the interior side of the porous barrier. The first volute may include a slurry input port. The slurry input port may provide flows of slurry into the first volute.

The slurry may then flow through the first cyclone opening into the interior side of the porous barrier to be separated by the hydrocyclone formed within the interior side of the porous barrier. The first volute may include a froth output port. The froth overflow port may be configured to receive froth outputted from hydrocyclone through the first cyclone opening and to output the froth from the apparatus. The apparatus may include a second volute. The second volute may include a body interface. The body interface may be attached to the second body opening to form a second cyclonic opening. The second cyclonic openings may provide fluid communication between the second volute and the interior side of the porous barrier.

The second volute may include an air column base that forms a base surface at the second primary barrier opening to retain froth within the core of the hydrocyclone. The base surface and a wall of the second volute may form an exhaust opening that is generally annular in shape. The exhaust opening may be configured to receive slurry exhausted from the hydrocyclone. The second volute may include an exhaust port. The exhaust port may be configured to provide fluid communication of slurry between the exhaust opening and the exterior of the apparatus.

These and other features, and characteristics of the present technology, as well as the methods of operation and functions of the related elements of structure and the combination of parts and economies of manufacture, will become more apparent upon consideration of the following description and the appended claims with reference to the accompanying drawings, all of which form a part of this specification, wherein like reference numerals designate corresponding parts in the various figures. It is to be expressly understood, however, that the drawings are for the purpose of illustration and description only and are not intended as a definition of the limits of the invention. As used in the specification and in the claims, the singular form of ‘a’, ‘an’, and ‘the’ include plural referents unless the context clearly dictates otherwise.

### BRIEF DESCRIPTIONS OF THE DRAWINGS

FIG. 1A illustrates an aerated hydrocyclone apparatus configured for cyclonic froth separation, in accordance with one or more implementations.

FIG. 1B illustrates a cross-sectional view of the apparatus that is parallel to the longitudinal axis of the central body, in accordance with one or more implementations.

FIG. 2A illustrates a cross-sectional view of the apparatus that is perpendicular to the longitudinal axis of the central body, in accordance with one or more implementations.

FIG. 2B illustrates a close-up view of a cross section of the apparatus that is perpendicular to the longitudinal axis of the central body, in accordance with one or more implementations.

FIG. 3 illustrates a porous barrier for an aerated hydrocyclone apparatus, in accordance with one or more implementations.

FIG. 4 illustrates a first volute for an aerated hydrocyclone apparatus, in accordance with one or more implementations.

FIG. 5A illustrates a second volute for an aerated hydrocyclone apparatus, in accordance with one or more implementations.

FIG. 5B illustrates a cross-sectional view of a second volute for an aerated hydrocyclone apparatus, in accordance with one or more implementations.

FIG. 6 illustrates a method for cyclonic froth separation of particles from a slurry, in accordance with one or more implementations.

FIG. 7 shows a block diagram of an overview flow chart of a hydrocyclone de-oiling device of one embodiment.

FIG. 8 shows for illustrative purposes only an example of a hydrocyclone desanding device prospective view of one embodiment.

FIG. 9 shows for illustrative purposes only an example of a hydrocyclone desanding device profile of one embodiment.

FIG. 10 shows for illustrative purposes only an example of a hydrocyclone desanding device cross section A-A of one embodiment.

FIG. 11 shows for illustrative purposes only an example of a hydrocyclone desanding device cross section C-C of one embodiment.

FIG. 12 shows for illustrative purposes only an example of a hydrocyclone desanding device cross section D-D of one embodiment.

FIG. 13 shows for illustrative purposes only an example of hydrocyclone desanding device prospective view of one embodiment.

FIG. 14 shows for illustrative purposes only an example of hydrocyclone desanding device profile of one embodiment.

FIG. 15 shows for illustrative purposes only an example of hydrocyclone desanding device cross section A-A of one embodiment.

FIG. 16 shows for illustrative purposes only an example of hydrocyclone desanding device cross section C-C of one embodiment.

FIG. 17 shows for illustrative purposes only an example of hydrocyclone desanding device cross section D-D of one embodiment.

FIG. 18 shows for illustrative purposes only an example of hydrocyclone desanding device prospective view of one embodiment.

FIG. 19 shows for illustrative purposes only an example of hydrocyclone desanding device profile of one embodiment.

FIG. 20 shows for illustrative purposes only an example of hydrocyclone desanding device cross section C-C of one embodiment.

FIG. 21 shows for illustrative purposes only an example of hydrocyclone desanding device cross section D-D of one embodiment.

FIG. 22 shows for illustrative purposes only an example of hydrocyclone desanding device cross section B-B of one embodiment.

FIG. 23 shows for illustrative purposes only an example of hydrocyclone desanding device cross section A-A of one embodiment.

FIG. 24 shows for illustrative purposes only an example of hydrocyclone deoiling device prospective view of one embodiment.

FIG. 25 shows for illustrative purposes only an example of hydrocyclone deoiling device cross section C-C of one embodiment.

FIG. 26 shows for illustrative purposes only an example of hydrocyclone deoiling device cross section A-A of one embodiment.

FIG. 27 shows for illustrative purposes only an example of hydrocyclone deoiling device cross section D-D interior view of one embodiment.

FIG. 28A shows for illustrative purposes only an example of hydrocyclone deoiling device DETAIL C of one embodiment.

FIG. 28B shows for illustrative purposes only an example of hydrocyclone deoiling device DETAIL C continuation of one embodiment.

FIG. 29 shows for illustrative purposes only an example of hydrocyclone desalination device prospective view of one embodiment.

FIG. 30 shows for illustrative purposes only an example of hydrocyclone desalination device cross section C-C of one embodiment.

FIG. 31 shows for illustrative purposes only an example of hydrocyclone desalination device cross section lines A, B, and C of one embodiment.

FIG. 32 shows for illustrative purposes only an example of hydrocyclone desalination device cross section A-A of one embodiment.

FIG. 33 shows for illustrative purposes only an example of hydrocyclone desalination device detail D-D of one embodiment.

### DETAILED DESCRIPTION OF THE INVENTION

In a following description, reference is made to the accompanying drawings, which form a part hereof, and in which is shown by way of illustration a specific example in which the invention may be practiced. It is to be understood that other embodiments may be utilized and structural changes may be made without departing from the scope of the present invention.

### General Overview

It should be noted that the descriptions that follow, for example, in terms of an aerated hydrocyclone apparatus and method for cyclonic froth separation is described for illustrative purposes and the underlying system can apply to any number and multiple types of water born particles. In one embodiment of the present invention, the aerated hydrocyclone apparatus and method for cyclonic froth separation can be configured using pressurized air. The aerated hydrocyclone apparatus and method for cyclonic froth separation can be configured to include water desalination and can be configured to include water deoiling using the present invention.

The terms used herein “hydrocyclone” and “cyclone” are used interchangeably without any change in meaning.

### DETAILED DESCRIPTION

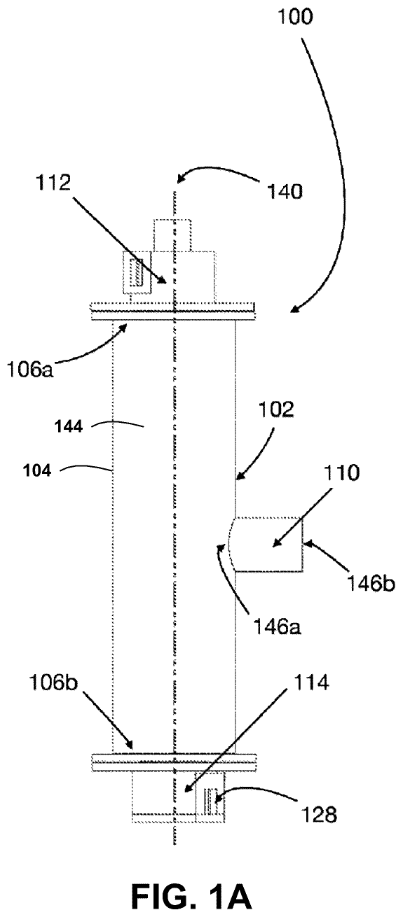

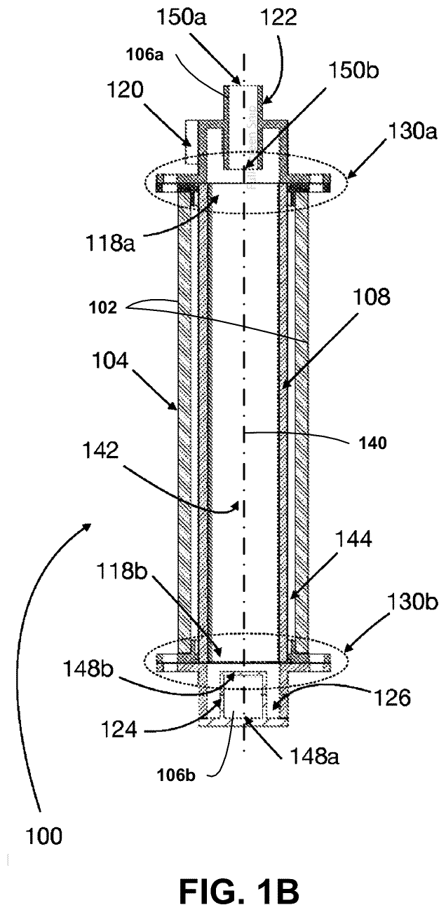

FIGS. 1A and 1B illustrates an aerated hydrocyclone apparatus 100 configured for cyclonic froth separation of particles from a slurry, in accordance with one or more implementations. FIG. 1A illustrates a view of the exterior of apparatus 100. FIG. 1B illustrates a cross-sectional view of apparatus 100, parallel to the longitudinal axis 140 of apparatus 100 (depicted by the dotted line of FIG. 1A). In some implementations, apparatus 100 may include one or more components. The components may include one or more of a central body 102, a porous barrier 108, a pressurized fluid port 110, a first volute 112, a second volute 114, and/or other components. Central body 102 may be formed of a body wall 104. In some implementations, body wall 104 may be hollow and run longitudinally from a first body opening 106a to a second body opening 106b. Second body opening 106b may be the end of body wall 104 opposite to first body opening 106a. In some implementations, porous barrier 108 may be housed inside central body 102. Porous barrier 108 may run longitudinally from a first primary barrier opening 118a to a second primary barrier opening 118b. Second primary barrier opening 118b may be the end of porous barrier 108 opposite to first primary barrier opening 118a. First volute 112 may include one or more of a slurry input port 120, a froth overflow port 122, and/or other components. Second volute 114 may include one or more of an airbase column 124, an exhaust opening 126, an exhaust port 128, and/or other components.

In some implementations, body wall 104 may have a generally cylindrical shape. Body wall may run longitudinally from first body opening 106a to second body opening 106b. In some implementations, first body opening 106a may have one or more of a circular shape, an oval shape, and/or other shapes. In some implementations second body opening 106b may have one or more of a circular shape, an oval shape, and/or other shapes. The length of central body 102 may run from first body opening 106a to second body opening 106b and/or may be determined by the length of body wall 104. The diameter of central body 102 may be determined by the shape and/or size of first body opening 106a and/or second body opening 106b.

FIG. 1A illustrates an aerated hydrocyclone apparatus configured for cyclonic froth separation, in accordance with one or more implementations. Referring to FIG. 1A, pressurized fluid port 110 may be configured to receive pressurized gaseous fluid through body wall 104. In some implementations, pressurized fluid port 110 may be positioned along body central body 102 between first body opening 106a and second body opening 106b. In some implementations, pressurized fluid port 110 may be positioned at one or more of midway between first body opening 106a and second body opening 106b, closer to first body opening 106a and further from second body opening 106b, further from first body opening 106a and closer to second body opening 106b, and/or at other positions.

In some implementations, pressurized fluid port 110 may be formed by one or more of a tube structure, a pipe structure, a channel structure, and/or other structures. By way of non-limiting example, a tube structure forming pressurized fluid port 110 may run longitudinally from a first port opening 146a on one end of the tube structure to a second port opening 146b on an end opposite first port opening 146a. By way of non-limiting example, FIG. 1A shows pressurized fluid port 110 may be positioned on central body 102 such that longitudinal axis 140 of central body 102 is generally perpendicular to the longitudinal axis of pressurized fluid port 110. In some implementations, first port opening 146a may be positioned on an interior side 144 of the body wall 104. In some implementations, second port opening 146b may be configured to attach to an external source containing pressurized gaseous fluid. By way of non-limiting example, pressurized gaseous fluid may flow from the external source through second port opening 146b, through first port opening 146a, and into the interior side 144 of body wall 104.

In some implementations, the diameter of pressurized fluid port 110 may be smaller or larger, wherein the size of the diameter may determine the amount of pressurized gaseous fluid flowing into the interior side 144 of body wall 104. In some implementations, the diameter of pressurized fluid port 110 may be smaller or larger, wherein the size of the diameter may determine the pressure of flowing pressurized gaseous fluid. In some implementations, pressurized fluid port 110 may include one or more of a pressure gauge to indicate the pressure of the gaseous fluid within pressurized fluid port 110, and/or other components.

FIG. 1B illustrates a cross-sectional view of the apparatus that is parallel to the longitudinal axis of the central body, in accordance with one or more implementations. Referring to FIG. 1B, porous barrier 108 may be housed within central body 102. Porous barrier may be positioned within central body 102 on the interior side 144 of body wall 104. In some implementations, the longitudinal axis of porous barrier 108 may be generally parallel to the longitudinal axis 140 of central body 102.

In some implementations, froth overflow port 122 may run longitudinally from a first output opening 150a to a second output opening 150b on the end opposite from the first output opening. In some implementations, froth may flow from the interior side 142 of porous barrier 108 through first cyclonic opening 130a into first volute 112. Body interface 502 may contact with second body opening 106b to form a second cyclonic opening 130b (indicated by a dashed circle in FIG. 1B). In some implementations, air base column 124 may be configured to prevent froth formed in the central air column from being outputted by exhaust port 128. The cylindrical structure may include a base end 148a and a base surface 148b opposite the base end 148a. The base end 148a of the cylindrical structure may make contact with a base of second volute 114. The base surface 148b of air base column 124 may extend to second cyclonic opening 130b.

By way of non-limiting example, the longitudinal axis of porous barrier 108 is shown to be generally parallel to the longitudinal axis 140 of central body 102. In some implementations, the misalignment of the longitudinal axis of porous barrier 108 and longitudinal axis 140 of central body 102 may vary within a range of 0 to 10 degrees. In some implementations, the length of porous barrier 108 from first primary barrier opening 118a to second primary barrier opening 118b may be generally the same as the length of body wall 104 from first body opening 106a to second body opening 106b. In some implementations, the longitudinal axis 140 of central body 102 may be the same as the longitudinal axis for porous barrier 108. In some implementations, a hydrocyclone may be housed on an interior side 142 of porous barrier 108. The hydrocyclone may be formed of a central air column surrounded by an outer layer of spiraling slurry. In some implementations, the length and diameter of porous barrier 108 may determine the flow rate of the layer of spiraling slurry.

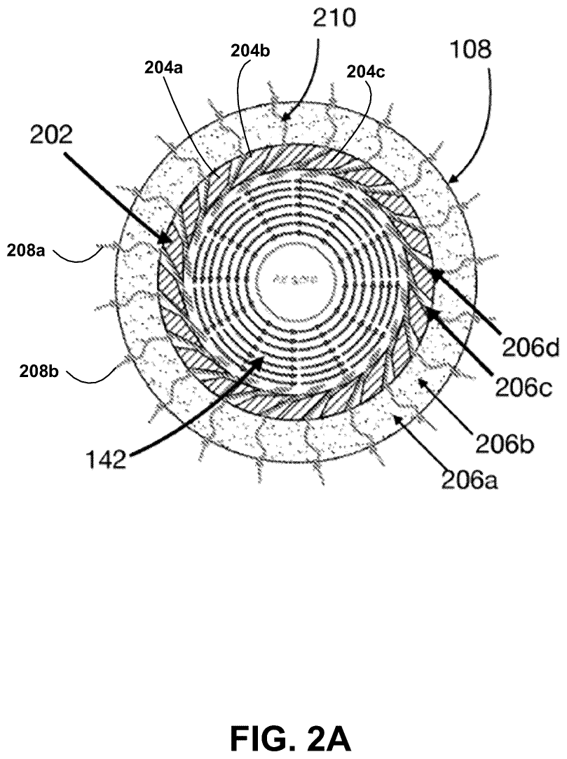

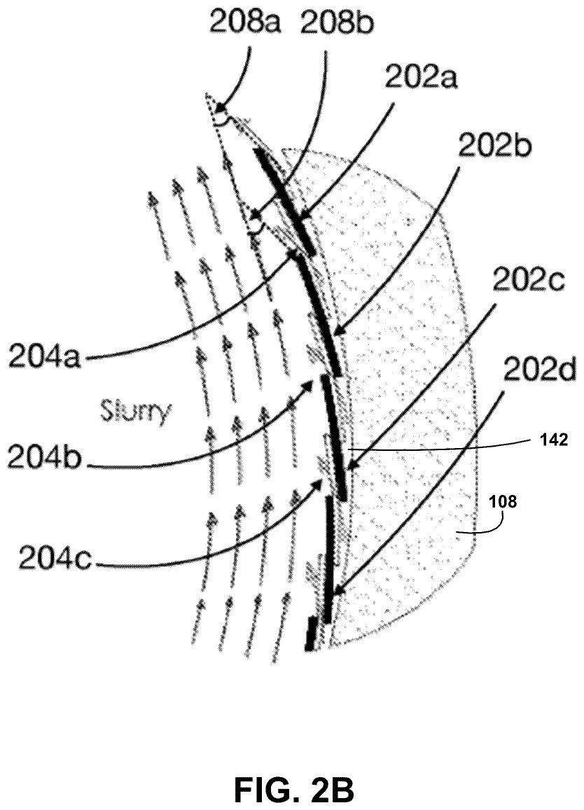

Referring to FIGS. 2A and 2B porous barrier 108 may include a cascade of blades 202 (also referred to as a set of blades). The cascade of blades 202 may be formed by one or more of individual blades 202a-d and/or other components. In some implementations the individual blades 202a-d of cascade of blades 202 may be overlapping. By way of non-limiting example, the cascade of blades 202 may be formed with a first edge of blade 202a positioned between a second edge of blade 202b and the porous barrier 108. The first edge of blade 202b may be positioned between a second edge of blade 202c and porous barrier 108. The first edge of blade 202c may be positioned between a second edge of blade 202d and porous barrier 108. In some implementations, one or more of the second edge of blade 202a, the second edge of 202b, the second edge of 202c, the second edge or 202d, and/or other components may contact porous barrier 108. In some implementations, cascade of blades 202 may form one or more of blade openings 204a-c between a first edge of an individual one of blades 202d and a second edge of an adjacent individual one of blades 202d. By way of non-limiting example, FIG. 2B illustrates a blade opening 204a between the second edge of blade 202a and the first edge of blade 202b. In some implementations, blade openings 204a-c may provide communication of pressurized gaseous fluid from the exterior side of porous barrier 108 through porous barrier 108 to the interior side 142 of porous barrier 108.

FIG. 2A illustrates a cross-sectional view of the apparatus that is perpendicular to the longitudinal axis of the central body, in accordance with one or more implementations. Referring to FIG. 2A, porous barrier 108 may include one more of secondary barrier openings 206a-d and/or other components. Secondary barrier openings 206a-d may be formed by one or more of, one or more pores of porous barrier 108, one or more blade openings 204a-c, and/or other formations. By way of non-limiting example, secondary barrier openings 206a and 206b may be formed by straight micro-channels and/or a network of micro-pores of porous barrier 108. Secondary barrier openings 206c and 206d may be the same as blade openings 204a and 204b, respectively. In some implementations, secondary barrier openings 206a-d may provide fluid communication of pressurize gaseous fluid between the exterior of porous barrier 108 and the interior side 142 of porous barrier 108. By way of non-limiting example, pressurized gaseous fluid may flow from the exterior of porous barrier 108, through one or more secondary barrier openings 206a-d to the interior side 142 of porous barrier 108. By way of non-limiting example, trajectory arrows 210 may exemplify the path of pressurized gaseous fluid from the exterior of porous barrier 108 into the interior side 142 of porous barrier 108.

In some implementations, pressurized gaseous fluid may be injected into the hydrocyclone through one or more of secondary openings 206a-d. Pressurized gaseous fluid may enter the interior side 142 of porous barrier 108 at a direction with a common directional tangential component. The common directional tangential component may be defined by an angle of injection 208a-b. The angle of injection 208a-b may be determined by the direction of the cyclonic motion of slurry of the hydrocyclone and/or the position of the individual blades 202a-d that form blade openings 104a-c. In some implementations, the angle of injection 208a-b may be the same for all points at which pressurized gaseous fluid enters the interior side 142 of porous barrier 108. The angle of injection 208a-b may be generally tangential to the cyclonic motion of slurry on the interior side 142 of porous barrier 108.

In some implementations, the pressurized gaseous fluid may flow from the secondary barrier openings and penetrate the outer layer of spiraling slurry of the hydrocyclone house on the interior side 142 of porous barrier 108. In some implementations, the injection of pressurized gaseous fluid may induce additional spiraling of the outer layer of slurry of the hydrocyclone on the interior side 142 of porous barrier 108.

In some implementations, the cascading direction of the set of blades 202 may prevent slurry from contacting the porous material forming porous barrier 108. By way of non-limiting example. FIG. 2B illustrates a close-up view of a cross section of the apparatus that is perpendicular to the longitudinal axis of the central body, in accordance with one or more implementations. FIG. 2B illustrates the direction of slurry motion on the interior side 142 of porous wall 108 and/or the overlapping edges of individual blades 202a-d may prevent the slurry from entering blade openings 204a-c. The cyclonic force on the interior side 142 of porous barrier 108 may cause the slurry to flow over the blade openings 204a-c, rather than into the blade openings. Preventing slurry from flowing into the blade openings 204a-c may prevent large particles within the slurry from clogging the porous material forming porous barrier 108.

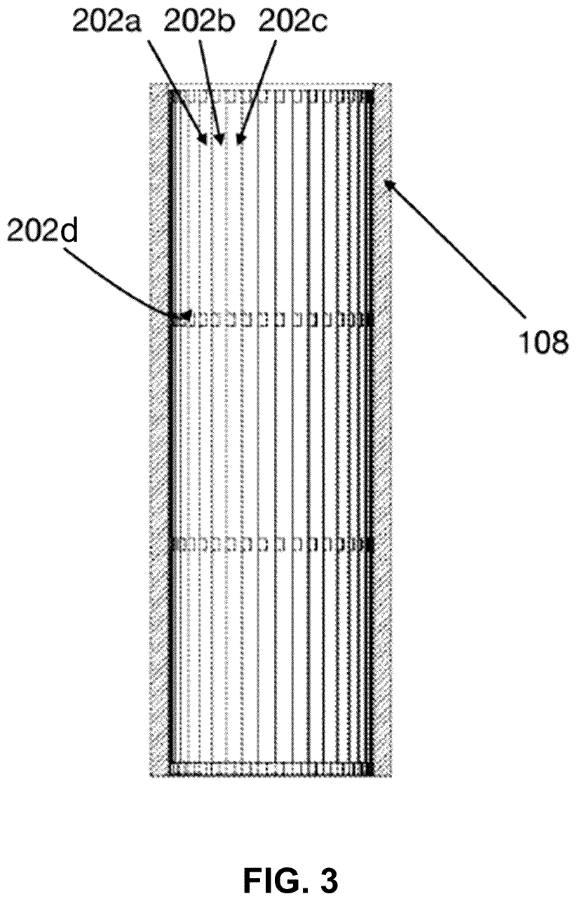

FIG. 3 illustrates a porous barrier for an aerated hydrocyclone apparatus, in accordance with one or more implementations. Referring to FIG. 3, the cascade of blades 202 may be formed by one or more of individual ones of blades 202a-d arranged in a generally cylindrical shape. In some implementations the individual blades of the cascade of blades 202 may run longitudinally from the first primary barrier opening to the second primary barrier opening of porous barrier 108. In some implementations, the individual blades of cascade of blades 202 may include more or less blades in its circumference. In some implementations, porous barrier 108 may include one or more cascades of blades. By way of non-limiting example, FIG. 3 illustrates porous barrier 108 with one cascade of blades 202, however other implementations may include one or more rows of cascades of blades and/or one or more layers of cascades of blades on the interior side 142 of porous barrier 108.

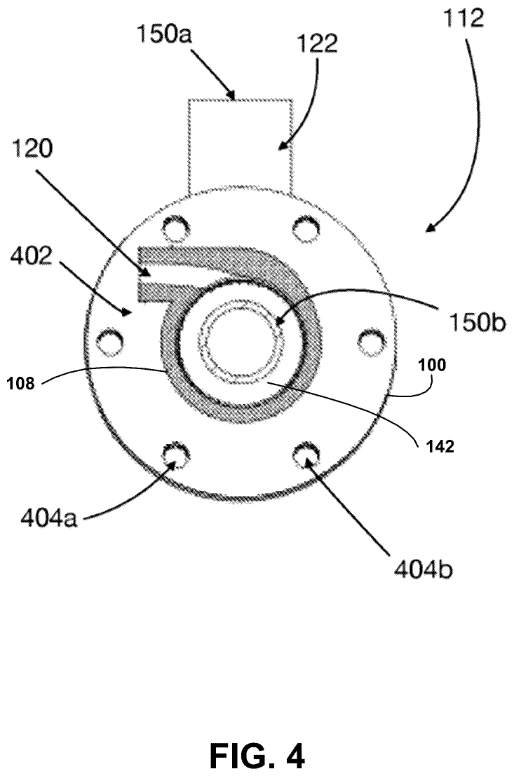

FIG. 4 illustrates a first volute for an aerated hydrocyclone apparatus, in accordance with one or more implementations. Referring to FIG. 4, first volute 112 may include slurry input port 120. In some implementations, slurry input port 120 may provide fluid communication between the exterior of apparatus 100 and first volute 112. In some implementations, slurry input port 120 may be formed by one or more of a tube structure, a pipe structure, a channel structure, and/or other structures. In some implementations, slurry input port 120 may be configured to attach to an external source containing slurry. In some implementations, slurry may enter first volute 112 at a direction that is tangential to the cyclonic motion of the layer of spiraling slurry of the hydrocyclone on the interior side 142 of porous barrier 108. In some implementations, the angle at which slurry flows through slurry input port 120 into first volute 112 may be determined by the position of slurry input port 120 on first volute 112. In some implementations, the momentum at which slurry is injected through slurry input port 120 may initiate the spiraling of the slurry as it forms the outer layer of the hydrocyclone housed on the interior side 142 of porous barrier 108.

Referring to FIG. 4, first volute 112 may include a body interface 402. In some implementations, first volute 112 may attach to central body 102 of FIG. 1A by body interface 402 contacting with first body opening 106a of FIG. 1A. Body interface 402 may contact first body opening 106a of FIG. 1A to form a first cyclonic opening 130a (indicated by a dashed circle in FIG. 1B). In some implementations, slurry may flow from first volute 112 through first cyclonic opening 130a of FIG. 1B into the interior side 142 of FIG. 1B of porous barrier 108 of FIG. 1B. Slurry may flow into and/or be incorporated into the outer layer of spiraling slurry of the hydrocyclone formed on the interior side 142 of FIG. 1B of porous barrier 108 of FIG. 1B. In some implementations, the outer layer of spiraling slurry within the hydrocyclone may be further propelled into cyclonic motion by pressurized gaseous fluid flowing from the secondary barrier openings 206a-d of FIG. 2A of porous barrier 108 of FIG. 1B.

In some implementations body interface 402 may have one or more of a circular shape, an oval shape, and/or other shapes. In some implementations, body interface 402 may have a generally similar shape to first body opening 106a of FIG. 1A. In some implementations body interface 402 may have a generally similar diameter to first body opening 106a of FIG. 1A. In some implementations, body interface 402 may include one or more of body interface bolt openings 404a-b. Body interface bolt openings 404a-b may be configured to house one or more components to attach body interface 402 to first body opening 106a of FIG. 1A. By way of non-limiting example, body interface bolt openings 404a-b may be configured to house one or more of a nut and bolt and/or other mechanisms for attachment.

Referring to FIG. 4, first volute 112 may include froth overflow port 122. In some implementations, froth overflow port 122 may provide fluid communication from first volute 112 to the exterior of apparatus 100 of FIG. 1A. Froth overflow port 112 may be formed of a tube structure, a pipe structure, a channel structure, and/or other structures. In some implementations, froth overflow port 122 may run longitudinally from a first output opening 150a to a second output opening 150b on the end opposite from the first output opening. In some implementations, first volute 112 may attach to central body 102 of FIG. 1A, such that the longitudinal axis of froth output port may be generally parallel with the longitudinal axis of central body 102 of FIG. 1A. In some implementations, first volute 112 may be attached to central body 102 of FIG. 1A, such that the second output opening 150b of froth overflow port 122 may be positioned longitudinally above the central air column of the hydrocyclone on the interior side of porous barrier 108 of FIG. 1B. In some implementations, the first output opening 150a of froth overflow port 122 may be configured to attach to an exterior component to house the outputted froth.

In some implementations, froth formed by the hydrocyclone may collect in the central air column of the hydrocyclone on the interior side 142 of FIG. 1B of porous barrier 108 of FIG. 1B. In some implementations, froth in the central air column may flow in a direction toward froth overflow port 122. In some implementations, froth may flow from the interior side 142 of FIG. 1B of porous barrier 108 of FIG. 1B through first cyclonic opening 130a of FIG. 1B into first volute 112. The froth may flow from first volute 112 to the exterior of apparatus 100 of FIG. 1A via froth overflow port 122. In some implementations, the length of froth overflow port 122 may be smaller or larger and may determine the amount and/or speed of froth outputted by apparatus 100 of FIG. 1A. In some implementations, the diameter of the tube structure forming froth overflow port 122 may be smaller or larger and may determine the amount and/or speed of froth outputted by apparatus 100 of FIG. 1A.

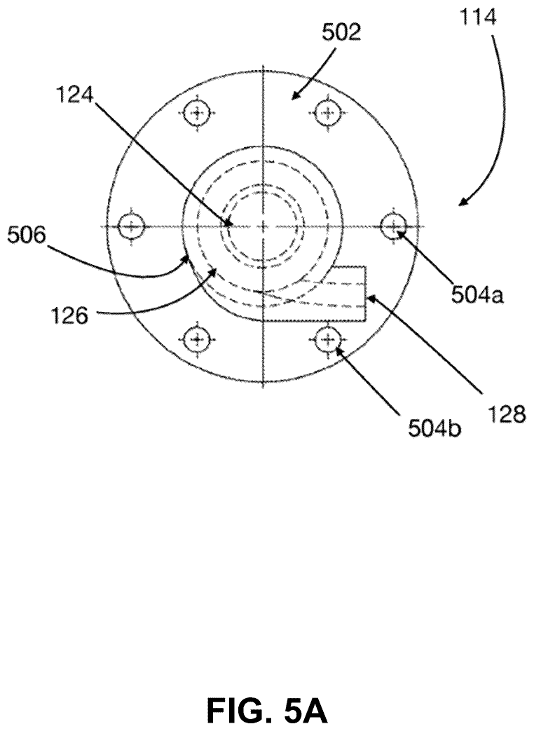

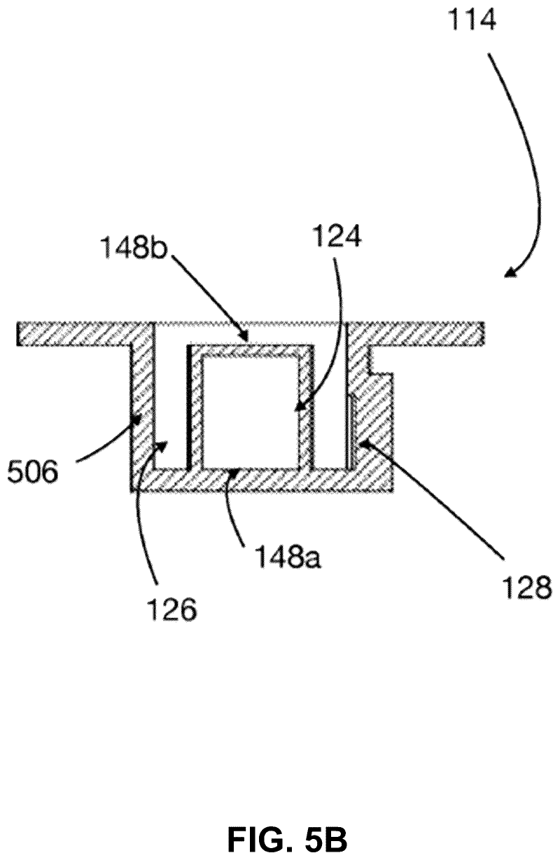

FIG. 5A illustrates a second volute for an aerated hydrocyclone apparatus, in accordance with one or more implementations. Referring to FIG. 5A, second volute 114 may include a body interface 502. In some implementations, second volute 114 may attach to central body 102 of FIG. 1A by body interface 502 contacting with second body opening 106b of FIG. 1A. Body interface 502 may contact with the second body opening 106b of FIG. 1A to form a second cyclonic opening 130b (indicated by a dashed circle in FIG. 1B). In some implementations, slurry exhausted by the hydrocyclone may flow from the interior side 142 of FIG. 1B of porous barrier 108 of FIG. 1B through second cyclonic opening 130b of FIG. 1B into second volute 114.

In some implementations body interface 502 may have one or more of a circular shape, an oval shape, and/or other shapes. In some implementations, body interface 502 may have a generally similar shape to second body opening 106b of FIG. 1A. In some implementations body interface 502 may have a generally similar diameter to first body opening 106b of FIG. 1A. In some implementations, body interface 502 may include one or more of body interface openings 504a-b. Body interface openings 504a-b may be configured to house one or more components to attach body interface 502 to first body opening 106b of FIG. 1A. By way of non-limiting example, body interface openings 504a-b may be configured to house one or more of a nut and bolt and/or other mechanisms for attachment.

FIG. 5B illustrates a cross-sectional view of a second volute for an aerated hydrocyclone apparatus, in accordance with one or more implementations. Referring to FIG. 5B, second volute 114 may include air base column 124. In some implementations air base column 124 may be configured to support the central air column of the hydrocyclone on the interior side 142 of FIG. 1B of porous barrier 108 of FIG. 1B. In some implementations, the central air column may be formed longitudinally from the first cyclonic opening 130a of FIG. 1B to the second cyclonic opening 130b of FIG. 1B. In some implementations, air base column 124 may be configured to prevent froth formed in the central air column from being outputted by exhaust port 128. In some implementations air base column 124 may be formed by a cylindrical structure. The cylindrical structure may include a base end 148a of FIG. 1B and a base surface 148b of FIG. 1B opposite the base end 148a of FIG. 1B. The base end 148a of FIG. 1B of the cylindrical structure may contact with a base of second volute 114. The base surface 148b of FIG. 1B of air base column 124 may extend to second cyclonic opening 130b of FIG. 1B. In some implementations, the diameter of air base column 124 may be slightly larger than the diameter of the central air column formed on the interior side 142 of FIG. 1B of porous barrier 108 of FIG. 1B.

In some implementations, the base surface 148b of FIG. 1B of air base column 124 may contact the central air column formed on the interior side 142 of FIG. 1B of porous barrier 108 of FIG. 1B in the second cyclonic opening 130b of FIG. 1B. In some implementations, air base column 124 may prevent air from the central air column to be outputted through exhaust port 128. In some implementations, air column base 124 may decrease the loss of kinetic energy and/or increase the cyclonic force of the hydrocyclone on the interior side 142 of FIG. 1B of porous barrier 108 of FIG. 1B.

Referring to FIG. 5B, second volute 114 may include exhaust opening 126. In some implementations, exhaust opening 126 may be formed by a wall 506 of volute 114 and air base column 124. In some implementations exhaust opening 126 may have a generally annular shape and may extend from the base of second volute 114 to second cyclonic opening 130b of FIG. 1B. In some implementations, the space forming exhaust opening 126 may be determined by the size and/or shape of airbase column 124 and/or the wall of second volute 114. In some implementations, exhaust opening 126 may be configured to provide fluid communication between second cyclonic opening 130b of FIG. 1B and exhaust output port 128. By way of non-limiting example, slurry in cyclonic motion on the interior side 142 of FIG. 1B of porous barrier 108 of FIG. 1B may also flow longitudinally from first cyclonic opening 130a of FIG. 1B to second cyclonic opening 130b of FIG. 1B. Slurry may flow through from the interior side 142 of FIG. 1B of porous barrier 108 of FIG. 1B through second cyclonic opening 130b of FIG. 1B into second volute 114 via the exhaust opening 126. In some implementations, slurry on the interior side 142 of FIG. 1B of porous barrier may flow in cyclonic motion around the central air column.

Referring to FIG. 5B, second volute 114 may include exhaust port 128. In some implementations, exhaust port 128 may provide fluid communication between second volute 114 and the exterior of apparatus 100 of FIG. 1A. In some implementations, exhaust port 128 may be formed by one or more of a tube structure, a pipe structure, a channel structure, and/or other structures. In some implementations, exhaust port 128 may be formed at the base of second volute 114 and/or may be formed in the wall 506 of second volute 114. In some implementations, exhaust port 128 may be configured to attach to an external component to house outputted slurry. In some implementations, slurry may flow into second volute 114 via exhaust opening 126. Slurry may flow from exhaust opening 126 through exhaust port 128 to the exterior of apparatus 100 of FIG. 1A. In some implementations, the length and/or diameter of the tube structure forming exhaust port 128 may be smaller or larger and may determine the rate at which slurry is outputted from apparatus 100 of FIG. 1A.

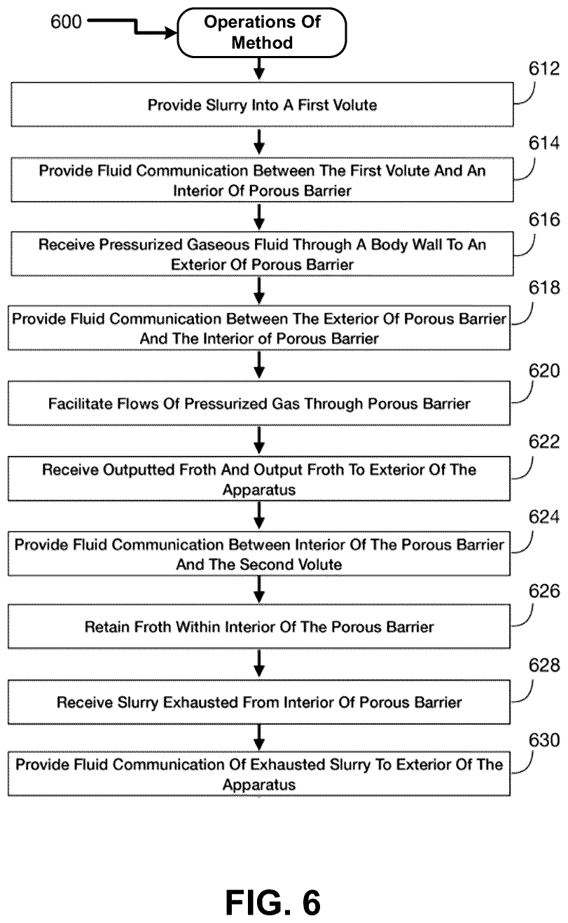

FIG. 6 illustrates a method for cyclonic froth separation of particles from a slurry, in accordance with one or more implementations. The operations of method 600 presented below are intended to be illustrative. In some implementations, operations of method 600 may be accomplished with one or more additional operations not described (i.e., slurry conditioning), and/or without one or more operations discussed. Additionally, the order in which the operations are illustrated in FIG. 6 and described below is not intended to be limiting.

An operation 612 may include providing slurry, via a slurry input port, into a first volute. Operation 612 may be performed by one or more components that is the same or similar to slurry input port 120 of FIG. 1B, in accordance with one or more implementations.

An operation 614 may include providing fluid communication between the first volute and the interior of a porous barrier to be separated by the hydrocyclone formed therein. Operation 614 may be performed by one or more components that is the same or similar to first cyclonic opening 130a of FIG. 1B, in accordance with one or more implementations.

An operation 616 may include receiving pressurized gaseous fluid through a body wall to an exterior of the porous barrier. The pressurized gaseous fluid being provided may generate the hydrocyclone on the interior of the porous barrier. Operation 616 may be performed by one or more components that is the same or similar to pressurized fluid port 110 of FIG. 1A, in accordance with one or more implementations.

An operation 618 may include providing fluid communication between the exterior of a porous barrier and the interior of the porous barrier. Operation 618 may be performed by one or more components that is the same or similar to secondary barrier openings 206a-d of FIG. 2A, in accordance with one or more implementations.

An operation 620 may include facilitating flows of pressurized gas through the porous barrier in directions that have a common directional tangential component to the longitudinal axis of the porous barrier to enhance cyclonic motion of the hydrocyclone formed within the interior of the porous barrier. Operation 620 may be performed by one or more components that is the same or similar to secondary barrier openings 206a-d of FIG. 2A, in accordance with one or more implementations.

An operation may include receiving outputted froth from the hydrocyclone formed in the interior of the porous barrier and outputting the froth to the exterior of the apparatus. Receive outputted froth and output froth to exterior of the apparatus 622. Operation may be performed by one or more components that is the same or similar to froth overflow port 122 of FIG. 1B, in accordance with one or more implementations.

An operation 624 may include providing fluid communication between the interior of the porous barrier and the second volute. Operation 624 may be performed by one or more components that is the same or similar to second cyclonic opening 130b of FIG. 1B, in accordance with one or more implementations.

An operation 626 may include retaining froth within the interior of the porous barrier. Operation 626 may be performed by one or more components that is the same or similar to air base column 124 of FIG. 1B, in accordance with one or more implementations.

An operation 628 may include retaining receiving exhausted slurry interior of the porous barrier. Operation 628 may be performed by one or more components that is the same or similar to exhaust opening 126 of FIG. 1B, in accordance with one or more implementations.

An operation 630 may include providing fluid communication of exhausted slurry from the exhaust opening to the exterior of the apparatus. Operation 630 may be performed by one or more components that is the same or similar to exhaust port 128 of FIG. 1B, in accordance with one or more implementations.

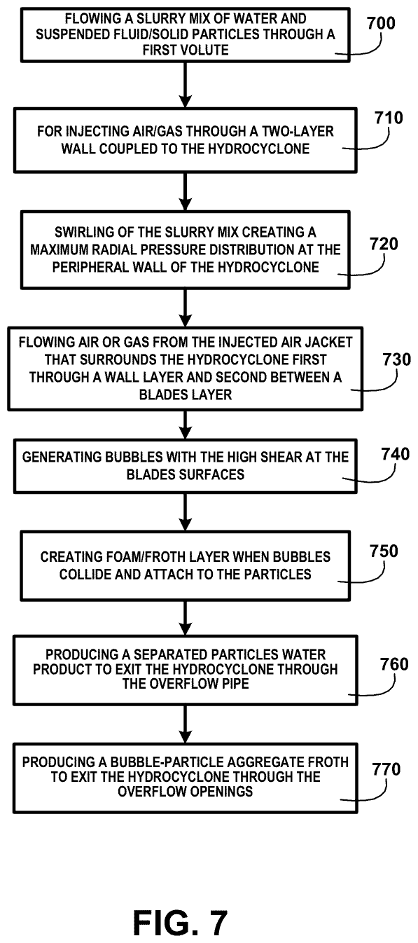

FIG. 7 shows a block diagram of an overview flow chart of a hydrocyclone de-oiling device of one embodiment. FIG. 7 shows a volute coupled to the hydrocyclone de-oiling device has spiral channels to accept flowing a slurry mix of water and suspended fluid/solid particles through a first volute 700. The spiral channels cause swirling of the slurry mix creating a maximum radial pressure distribution at the peripheral wall of the hydrocyclone 710. The slurry mix is directed to the interior of the hydrocyclone peripheral wall. An air/gas base is configured for injecting air/gas through a two-layer wall coupled to the hydrocyclone 720 forming an air jacket. The injected flowing air or gas flows from the air jacket that surrounds the hydrocyclone through the blades layer 730. The air/gas is flowed over the blades for generating bubbles with the high shear at the blades surfaces 740. The bubbles are generated for creating foam/froth layer when bubbles collide and attach to the particles 750. The bubble-particle aggregates form a froth separated from the water. The creation of the froth is producing a separated particles water product to exit the hydrocyclone through the overflow pipe 760. The froth carrying the particles Is producing a bubble-particle aggregate froth to exit the hydrocyclone through the underflow openings 770.

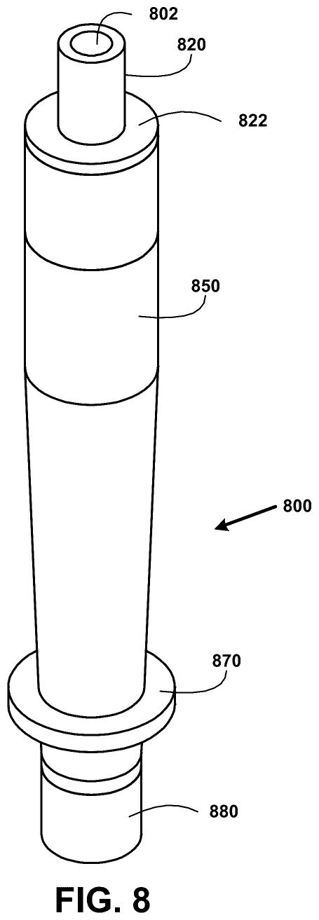

FIG. 8 shows for illustrative purposes only an example of a hydrocyclone desanding device prospective view of one embodiment. FIG. 8 Showing are a slurry inlet 802 coupled to the hydrocyclone desanding device configured to enter a slurry mix of water and particles into the hydrocyclone desanding device. An overflow pipe 820 with an inlet for introducing the slurry mix and directing it toward the volute 822. The volute 822 spiral channel causes the slurry mix to swirl at a high rate against the interior of the hydrocyclone wall 850. The hydrocyclone inlet opening 802 receives gas, water and solid particles and swirls inside the body of the cyclone. The slurry phases are separated due to the large centrifugal acceleration and solid particles exit from the underflow opening that has annular shape at the bottom of the cyclone. The air/gas forms a core inside the cyclone and exit through the overflow because of the air/gas base 870. The pressurized air forces the slurry separates from the slurry and create air/gas core that is standing on the base 870. The solid particles separates and moves towards the wall of the cyclone 850. The design of axial annular underflow exit of the desanding cyclone can allow us to control the split ratio of water and solid particles to prevent clogging of the underflow. The water and other light particles exit through the top overflow pipe 820.

The hydrocyclone desanding device 800 performs continuous desanding of wellhead discharge stream water in the oil industry. The hydrocyclone desanding device 800 includes multiple openings 880 to allow for a continuous separation of the sand from the wellhead upstream without the need to stop the production. The flow of atmospheric air is not allowed because of the annular configuration of the underflow openings 880. This new annular configuration will allow for a continuous production of the oil and reduce the operational cost. FIG. 8 shows a hydrocyclone desanding device 800 to clean solid particles from water.

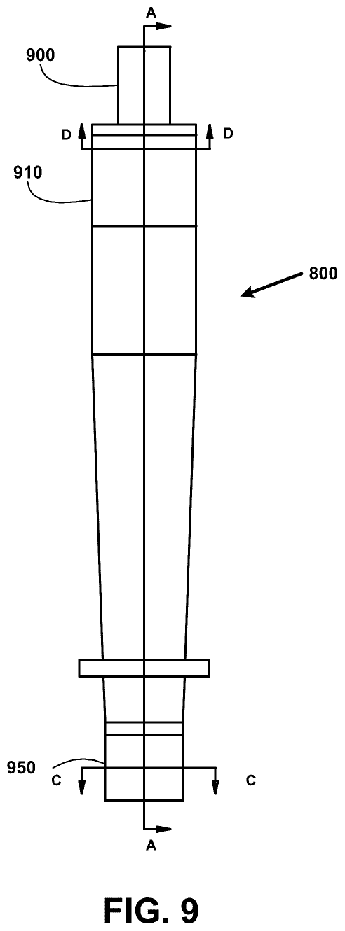

FIG. 9 shows for illustrative purposes only an example of a hydrocyclone desanding device profile of one embodiment. FIG. 9 shows a profile of the hydrocyclone desanding device 800 having an overflow pipe 900, a body 910, and an air/gas base 950. The overflow pipe 900 allows a slurry mix to be poured into the hydrocyclone desanding device and sand free water to exit the hydrocyclone desanding device. The air/gas base 950 support the gas core and prevents the external air from flowing into the cyclone. This new design feature of the air/gas base allow for continuous desanding operation where the flow of sand is allowed to exit in one direction through the annular underflow. The air base support the air/gas core and prevent the inward flow of air into the cyclone.

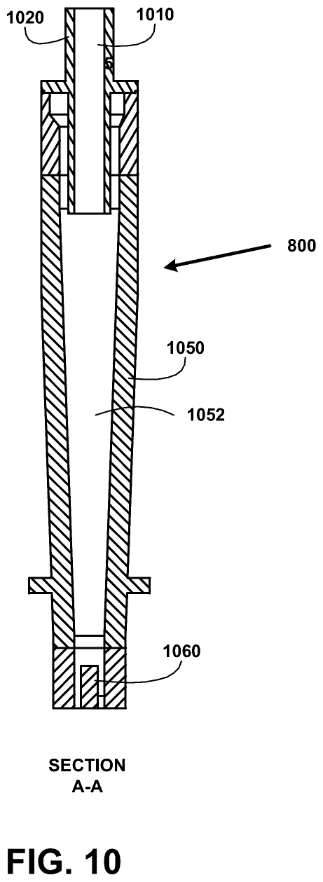

FIG. 10 shows for illustrative purposes only an example of a hydrocyclone desanding device cross section A-A of one embodiment. FIG. 10 shows cross section A-A of the hydrocyclone desanding device 800. The volute 1010 and overflow pipe 1020 are coupled to the hydrocyclone desanding device 800 to feed the slurry mix in a swirling high rate for processing in the two layers of the interior from the hydrocyclone wall 850 of FIG. 8.

An air/gas base 1060 coupled to the hydrocyclone desanding device prevents the flow of air into the interior from the hydrocyclone wall 850 of FIG. 8. The high centrifugal acceleration creates phase separation where air/gas core stands on the air base, surrounding by water column and solid particles flows towards the wall 1050. The design of the hydrocyclone allows for controlling the split ratio of water such that high solid concentration of solids will be prevented to avoid clogging problems of the underflow exit port 1140. The particle free water and air/gas then exit through the overflow pipe 900 of FIG. 9.

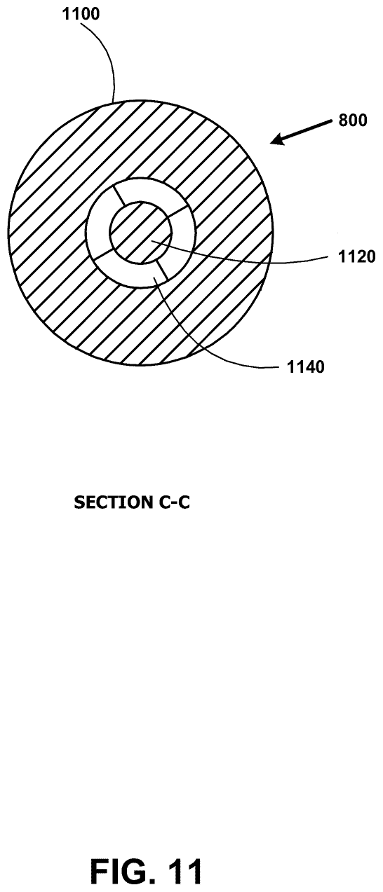

FIG. 11 shows for illustrative purposes only an example of a hydrocyclone desanding device cross section C-C of one embodiment. FIG. 11 shows cross section C-C of the hydrocyclone desanding device 800 having the hydrocyclone wall 1100 that shows the annular exit of underflow. The central air/gas base 1120 supports the air/gas core and prevents the external air from flowing into the cyclone through the underflow port.

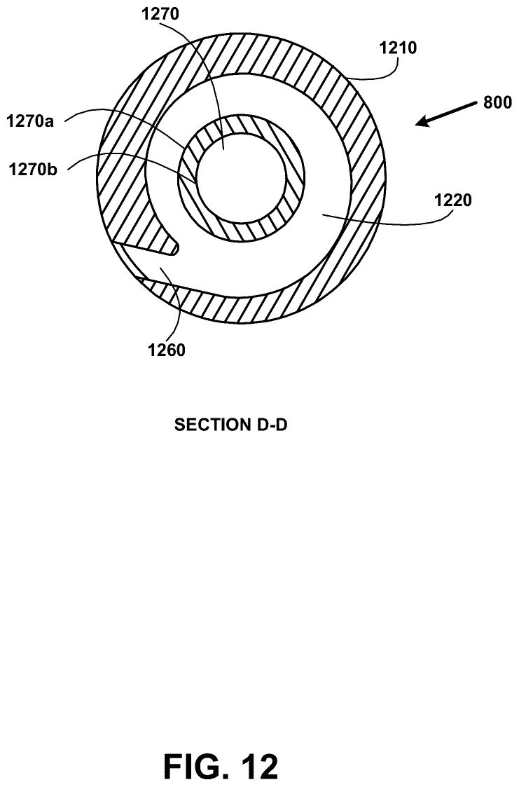

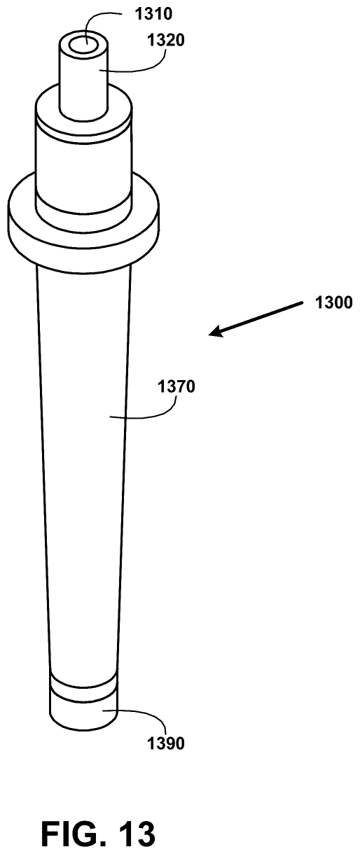

FIG. 12 shows for illustrative purposes only an example of a hydrocyclone desanding device cross section D-D of one embodiment. FIG. 12 shows cross section D-D of the hydrocyclone desanding device 800 having the core 1270 surrounded by the, hydrocyclone wall 1210. Coupled to the hydrocyclone wall 1210 is a tangential slurry inlet 1260 coupled to a volute spiral 1220 to impart a swirling motion to the slurry at a high rate. The underflow opening 880 of FIG. 8 is configured in a ring shape, which allows the flow of solid particles and water to move outward along the hydrocyclone wall 1370 of FIG. 13. The diameter of the overflow pipe 1270b is determined to control the rate of water flow rates that reports to the overflow and hence controlling the split ratio. The outer diameter of the overflow pipe 1270a is determined to prevent water short-circuiting to the overflow pipe. This configuration separates the low-pressure area in the center core 1270 from the high-pressure area at the hydrocyclone wall 1370 of FIG. 13. By adjusting the pressure at the underflow opening 880 of FIG. 8 exit, the ratio of liquid and solids can be controlled, helping to prevent clogging. Controlling the underflow pressure ensures there is enough water flow to carry the solids and prevents blockages from fine or ultra-fine particles. This pressure control helps maintain a smooth flow and avoid issues like the underflow stream becoming blocked.

FIG. 13 shows for illustrative purposes only an example of hydrocyclone desanding/desliming device prospective view of one embodiment. The design of this cyclone has been developed to prevent clogging issues of the underflow. FIG. 13 shows the hydrocyclone desliming device 1300 having a hydrocyclone wall 1370 fed a slurry mix from a volute 1310 entered from an inlet tube 1320. An air/gas base 1390 injects air into the interior of the hydrocyclone wall 1370.

Parameters are optimized to determine the optimum range for these parameters. The width of the inlet opening of the inlet tube 1320 should be in the range of 50%-30% of the annular radial thickness of the cyclone. This width of the inlet opening is needed to maintain strong inlet angular momentum to produce the required swirling velocity in the cyclone. The depth of the inlet tube 1320 is in proportion to the cyclone throughput rate and it can be determined to achieve the inlet velocity in the range of 3 m/s-5 m/s. The optimum height of the overflow pipe 900 of FIG. 9 is based on the cyclone diameter. The cyclone's conical angle has major effects on the level of turbulence in the cyclone. The cyclone is used to separate solid phases from the liquid phase and to maintain low levels of turbulence inside the cyclone to achieve high-efficiency separation. The conical angle shall be in the range of 0 to 10 degrees to achieve very low levels of turbulence inside the cyclone. Therefore, the cyclone height and exit underflow diameter will be determined based on the conical angle and cyclone diameter. The size of the underflow opening is determined by the ratio. This ratio can be in the range of 1.2-1.4 depending on the cyclone diameter. This annular structure of the underflow opening will prevent the underflow recirculation phenomena in cyclones. The split ratio of liquids can be controlled by slight adjustment of the outside pressure at the underflow. Therefore, the mass loading of the slurry leaving the underflow can be controlled to prevent clogging problems that occur in desliming.

Another application is the continuous desanding of wellhead streams in the oil industry. The production operation must be shut down for 6-18 hours to remove the collected sand in the accumulator which reduces oil production by a factor of 10% and increases the operational cost due to the removal of the sand and resumption of the upstream flow.

The new design of annular underflow can allow for a continuous separation of the sand from the wellhead upstream without the need to stop the production. The flow of atmospheric air is not be allowed because of the annular configuration of the underflow opening, allowing continuous production of the oil, and reducing the operational cost.

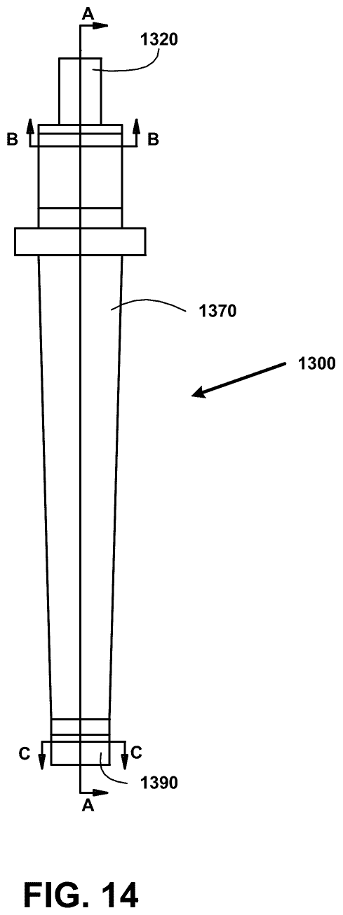

FIG. 14 shows for illustrative purposes only an example of hydrocyclone desanding/desliming device profile of one embodiment. FIG. 14 shows the hydrocyclone desanding device 1300 having a hydrocyclone wall 1370. The volute 1310 receives a slurry mix from the inlet tube 1320. The air/gas base 1390 forces air/gas to exit only through the overflow opening and prevents inflow of air through the underflow opening.

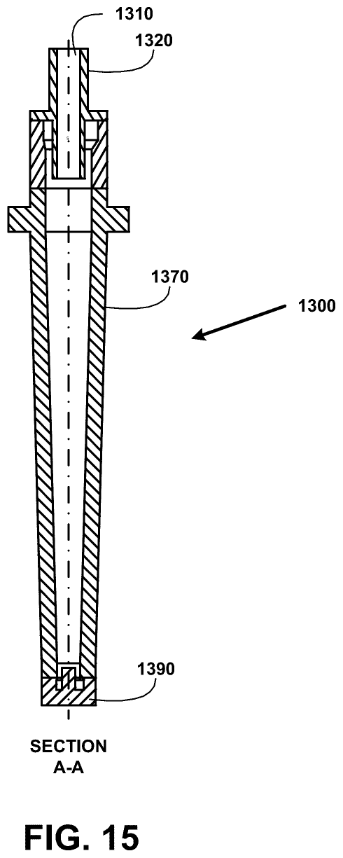

FIG. 15 shows for illustrative purposes only an example of hydrocyclone desliming/desanding device cross section A-A of one embodiment. FIG. 15 shows the hydrocyclone desanding device 1300 having a hydrocyclone wall 1370, a volute 1310, an inlet tube 1320, and an air/gas base 1390.

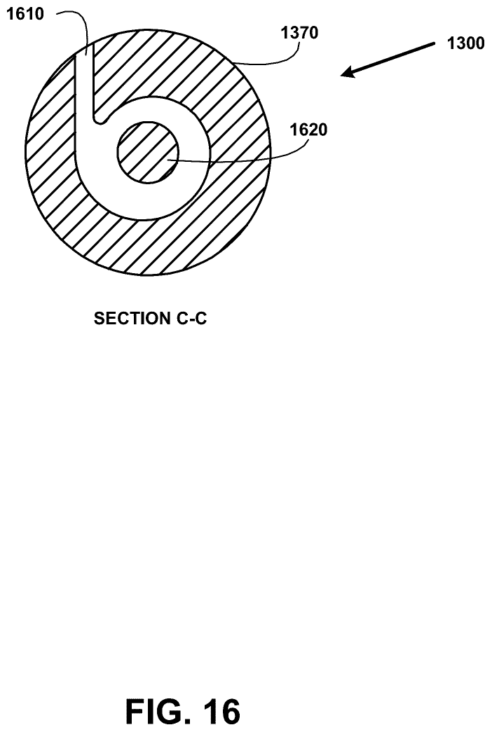

FIG. 16 shows for illustrative purposes only an example of hydrocyclone desliming/device cross section C-C of one embodiment. FIG. 16 shows the hydrocyclone desliming/device device 1300 having a hydrocyclone wall 1370 of FIG. 13. The tangential slurry inlet 1610 of the volute receives the slurry mix and swirls the slurry mix at a high rate around the core 1620.

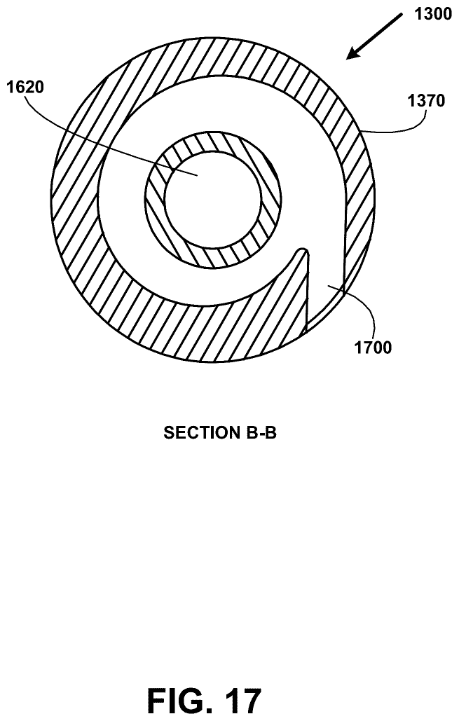

FIG. 17 shows for illustrative purposes only an example of hydrocyclone desanding device cross section D-D of one embodiment. FIG. 17 shows the hydrocyclone desanding device 1300 having a hydrocyclone wall 1370. A common directional tangential component 1700 directs flows of slurry that contains air/gas, solid particles to swirle strongly in the tangential direction through the cyclone body.

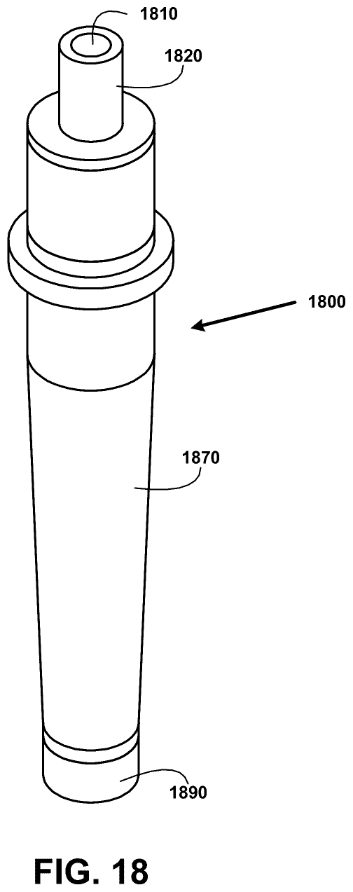

FIG. 18 shows for illustrative purposes only an example of hydrocyclone desliming/desanding device prospective view of one embodiment. FIG. 18 shows the hydrocyclone desanding device 1800 with the inlet tube 1820 allowing slurry mix to be flowed into a volute 1810. The volute 1810 swirls the slurry mix at a high rate into the interior of the hydrocyclone wall 1870. The air/gas base 1890 supports air column and prevent the entrance of external air/gas from entering the body of the cyclone through the underflow port.

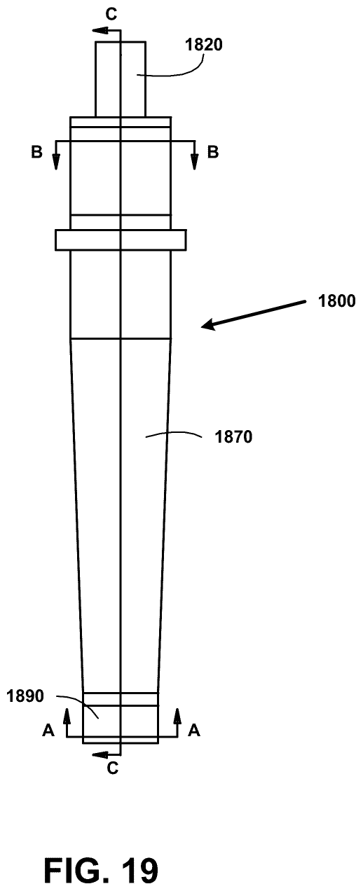

FIG. 19 shows for illustrative purposes only an example of hydrocyclone desanding device profile of one embodiment. FIG. 19 shows the hydrocyclone desanding device 1800 having a hydrocyclone wall 1870. An inlet tube 1820 receives a flow of the slurry mix to be processed by high centrifugal acceleration and create a controlled phase separation where the air/gas base 1890 controls the water split ratio and prevent the inward flows of gases into the cyclone from the underflow exit.

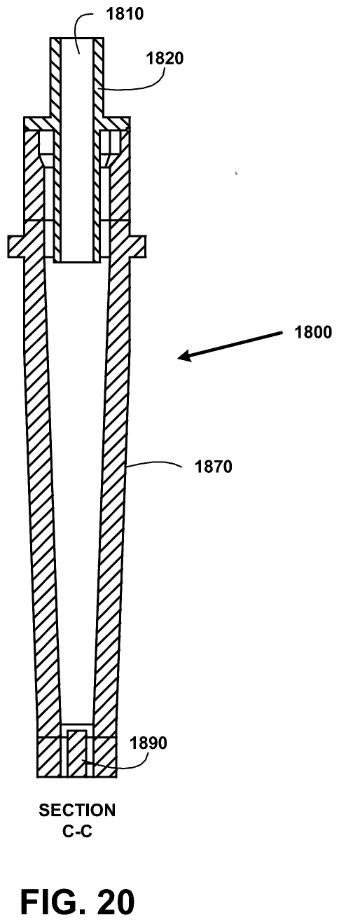

FIG. 20 shows for illustrative purposes only an example of hydrocyclone desanding device cross section C-C of one embodiment. FIG. 20 shows the inlet tube 1820 receiving the slurry mix and feeding the slurry mix into the volute 1810. The hydrocyclone desanding device 1800 having a hydrocyclone wall 1870 to receive on the interior of the high-rate swirling slurry mix from the volute 1810. The air/gas base 1890 controls the water split ratio and prevent the inward flows of gases into the cyclone from the underflow exit.

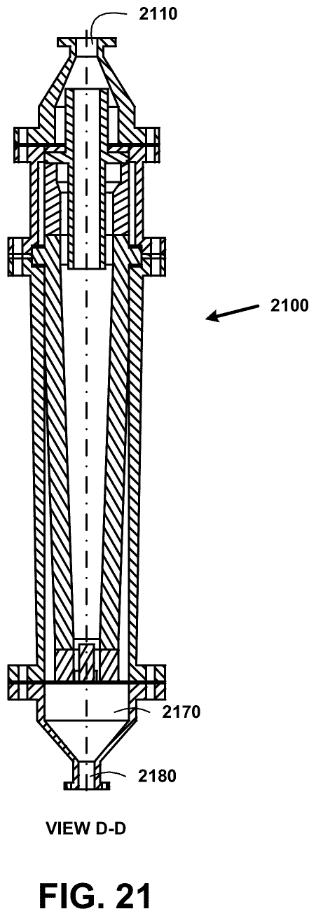

FIG. 21 shows for illustrative purposes only an example of hydrocyclone desanding device cross section D-D of one embodiment where it is included inside steel casing for high pressure applications. FIG. 21 shows an accumulator 2100 that couples to the hydrocyclone desanding device 1800 of FIG. 18. FIG. 21 shows also a volute 2110 that directs the slurry mix to create controlled phase separation inside the body of the cyclone. An accumulator 2100 is designed to collect sand particles. The accumulator 2100 directs the separated particles to an underflow 2170 coupled to a sand exit 2180 to allow for continuous discharge of sand particles including sand to the exterior of the hydrocyclone desanding device 1800 of FIG. 18.

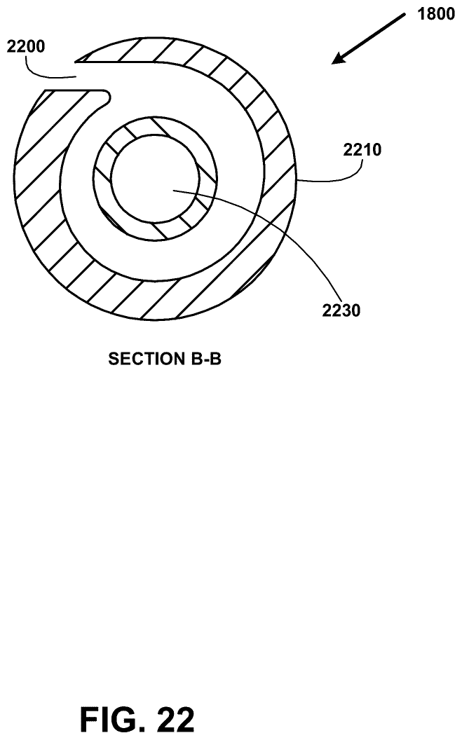

FIG. 22 shows for illustrative purposes only an example of hydrocyclone desanding device cross section B-B of one embodiment. FIG. 22 shows the hydrocyclone desanding device 1800 with a hydrocyclone wall 2210 having a tangential slurry inlet 2200 to receive a slurry mix and impart a high rate of swirling to process on the interior of the hydrocyclone wall 2210 around the core 2230 for a separation of particles from the water.

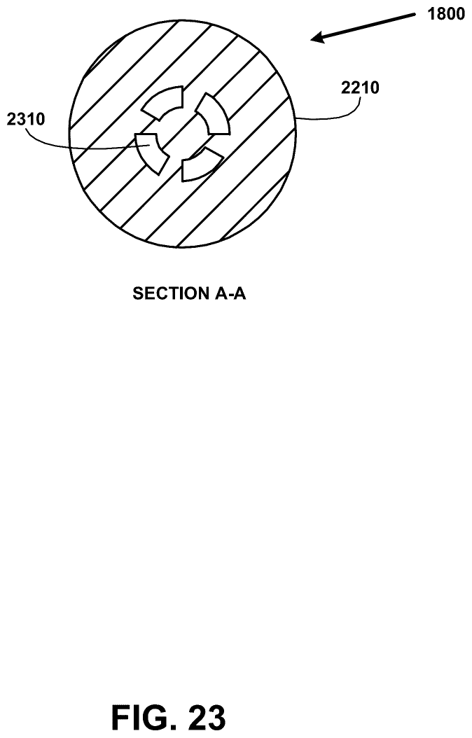

FIG. 23 shows for illustrative purposes only an example of hydrocyclone desanding device cross section A-A of one embodiment. FIG. 23 shows the hydrocyclone desanding device 1800 having a hydrocyclone wall 2210. Near the bottom of the hydrocyclone wall 2210 are exit openings 2310 to pass the separated particles to the exterior of the hydrocyclone desanding device 1800.

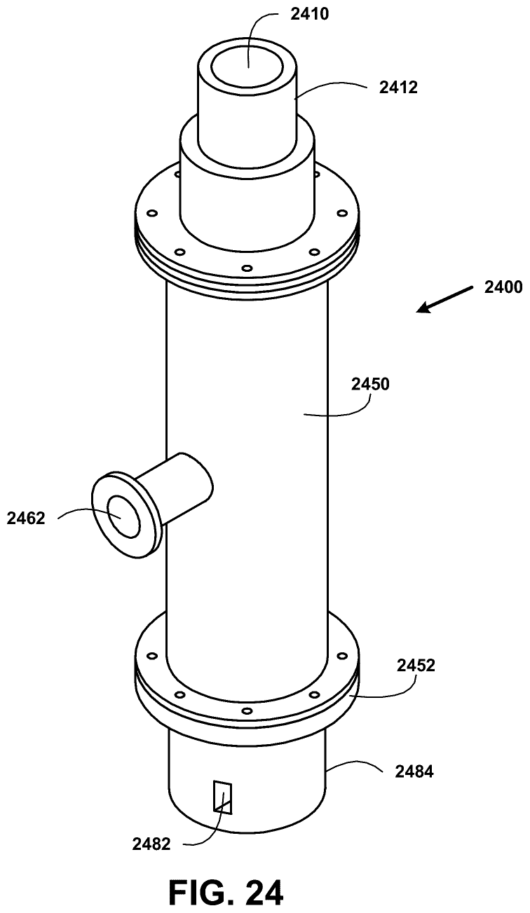

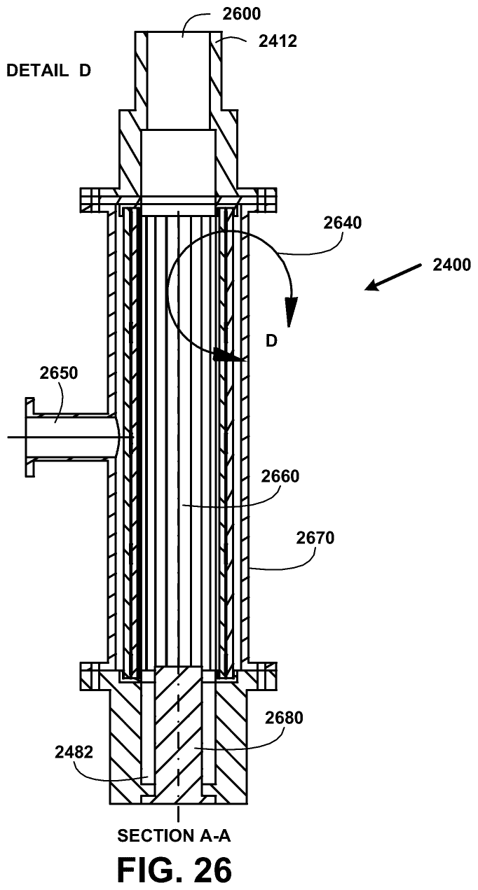

FIG. 24 shows for illustrative purposes only an example of hydrocyclone deoiling device prospective view of one embodiment. FIG. 24 shows a hydrocyclone deoiling device 2400 to process an aerated cyclonic extraction of oil from water. The oil and water are flowed into the hydrocyclone deoiling device 2400 through an oil/water inlet opening 2482 near the bottom of the hydrocyclone deoiling device 2400. Pressurized air is injected into the hydrocyclone deoiling device 2400 through an air/gas supply pipe 2462 from the side of the hydrocyclone deoiling device 2400. In this process oil droplets are attaching to bubbles and form aggregates of oil and air that flows through the overflow opening 2410. This aggregate is called herein the concentrate that flows into a shallow flotation tanks and form a stable froth/foam layer on top the flotation tank. The slurry of oil and water enters the hydrocyclone deoiling device 2400 through the oil/water inlet opening 2482. A gas enters through a pressurized air/gas fluid inlet 2462 to the gas jacket 2660 of FIG. 26 that surrounds the hydrocyclone deoiling device 2400 chamber. The slurry flows and interacts with gas bubbles inside the cyclone chamber. The concentrate product exits from the overflow opening 2410 of the hydrocyclone deoiling device 2400 at the top of the cyclone. The slurry can be fed in a tangential direction from a volute 2452 opening near the bottom of the cyclone and the concentrate product exits from the overflow opening 2410 that is installed in the center of the cyclone at the top end. The concentrate of hydrophobic particles (oil) and bubbles aggregates exit from the top overflow opening 2410. The cleaned water will be flowing from the underflow of the flotation tank and oil will be skimmed from the tank top.

The use of the aerated hydrocyclone deoiling device 2400 includes a separation process of hydrophobic fine material in water for a non-selective separation process including the removal of all suspended solid particles and immiscible droplets in water. The process generates micro-bubbles to remove suspended hydrophobic particles material in water. The hydrocyclone deoiling device has two inlets for slurry and gas and one exhaust opening for the mixture of slurry and microbubbles aggregates. For example, one slurry inlet, one gas inlet, and one overflow outlet. The mixture of water and the concentrate of hydrophobic particles (oil) and bubbles aggregates overflow into a shallow flotation tank where the hydrophobic particles (oil)-bubbles aggregates stay at the top surface of the tank. The hydrophobic particles (oil)-bubbles aggregates at the top surface of the tank allowing harvesting of the dispersed oil in produced water from the wellhead.

The current technology of hydraulic fracking uses massive amounts of water to enhance oil recovery from the oil reservoirs. The use of large amounts of water results in a highly dispersive mixture of oil, water, gas, and sand. That is roughly 70% water 25% oil, 4% gas, and 1% sand. This mixture at the wellhead represents a challenge for oil companies to separate these phases at the wellhead and it would increase the production cost of oil. The hydrocyclone deoiling device 2400 cyclone extracts tiny oil droplets from water using micro-bubbles. A set of hydrocyclone deoiling device 2400 cyclones are installed and connected to a shallow flotation tank. The mixture of oil and water enters the hydrocyclone deoiling device 2400 cyclone from the bottom oil/water inlet opening 2482 and flows inside the cyclone in a combined swirling and upward axial motion. The micro-bubbles of gas are generated near the hydrocyclone wall 2450 of the cyclone similar to the mechanism of “AERATED HYDROCYCLONE APPARATUS AND METHOD FOR CYCLONIC FROTH SEPARATION.” The high swirling velocity of the slurry creates high centrifugal acceleration that produces large relative velocity between slurry and micro-bubbles. The micro-bubbles collide and attach to oil droplets and create a stable bubble-droplet aggregate. These aggregates flow upward with slurry and exit from the oil and water slurry inlet opening 2410 at the top of the overflow pipe 2412 into a flotation tank and create a stable froth/foam. This foam is harvested by skimming to recover the oil and water exits from the bottom of the flotation tank.

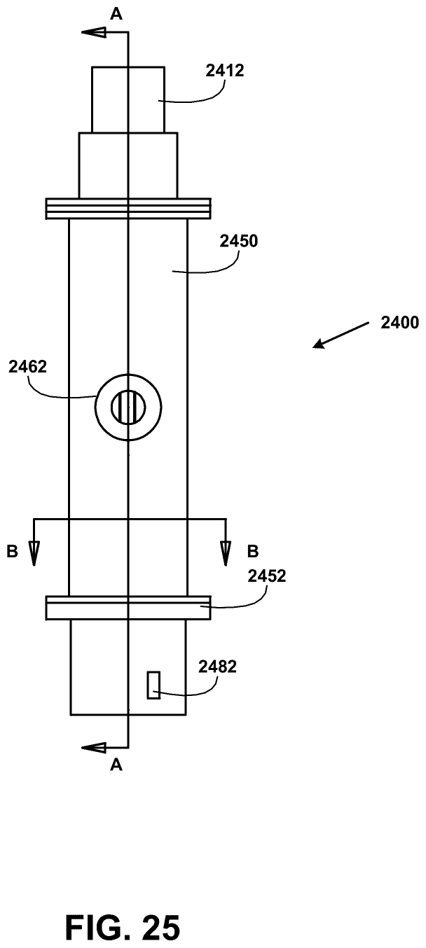

FIG. 25 shows for illustrative purposes only an example of hydrocyclone deoiling device cross section C-C of one embodiment. FIG. 25 shows the cross section (C-C) in an Isometric view. Showing are the hydrocyclone deoiling device 2400 hydrocyclone aerated cyclonic extraction of oil from water having the hydrocyclone body 2450. Concentrate overflow opening tube 2412, volute 2452, air/gas supply pipe 2462, Section line B of the hydrocyclone wall 2450, and oil/water inlet 2482.

FIG. 26 shows for illustrative purposes only an example of hydrocyclone deoiling device cross section A-A of one embodiment. FIG. 26 shows the oil and water slurry entering the hydrocyclone deoiling device 2400 through the oil/water inlet 2482. Pressurized gas is injected through the air/gas pressurized fluid port 2650. A gas jacket 2670 fills the interior area against the hydrocyclone wall 2660. The concentrate of hydrophobic particles (oil) and bubbles aggregates exit from top overflow opening 2600 of the overflow opening tube 2412. The air/gas base 2680 supports the air/gas column and maintain stable swirling layers of slurry inside the cyclone.

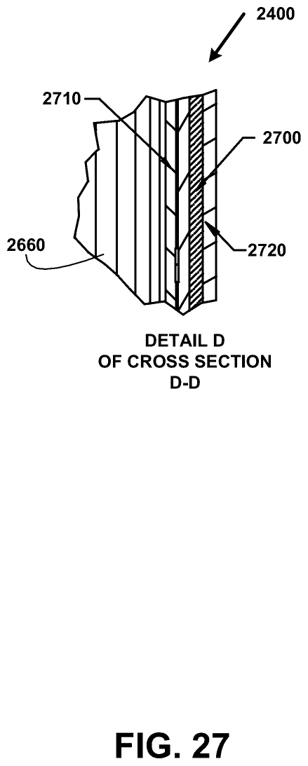

FIG. 27 shows for illustrative purposes only an example of hydrocyclone deoiling device cross section D-D interior view of one embodiment. FIG. 27 shows the hydrocyclone aerated cyclonic extraction of oil from water device 2400 having pressurized air/gas forming a gas jacket between the hydrocyclone wall 2450 of FIG. 24 and the cascaded blades 2700. An air jacket wall 2720 separates a gas jacket 2660 from the cascaded blades 2710 in Detail D.

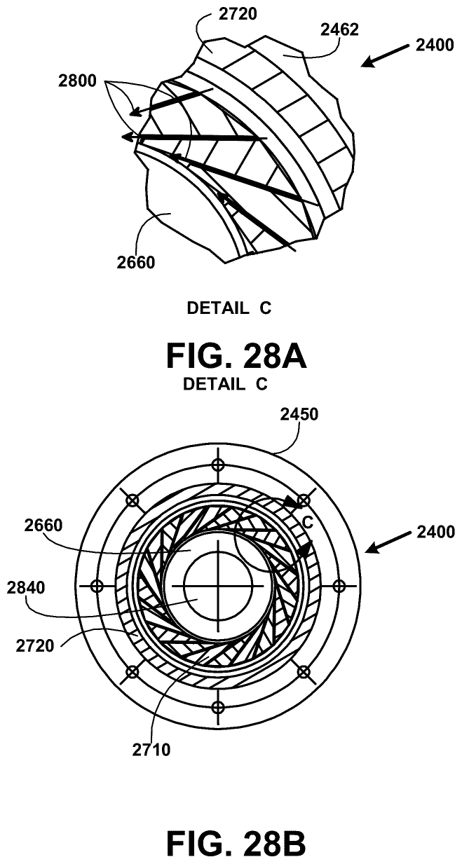

FIG. 28A shows for illustrative purposes only an example of hydrocyclone deoiling device DETAIL C of one embodiment. FIG. 28A shows the hydrocyclone deoiling device 2400 to process aerated cyclonic extraction of oil from water with Detail C. Detail C shows the air jacket wall 2720, pressurized air/gas fluid inlet 2462, air/gas flow between blades 2800, and the gas jacket 2660.

FIG. 28B shows for illustrative purposes only an example of hydrocyclone deoiling device DETAIL C continuation of one embodiment. FIG. 28B shows the hydrocyclone deoiling device 2400 aerated cyclonic extraction of oil from water with a continuation of Detail C. Showing are the hydrocyclone wall 2450 enclosing the gas jacket 2660 separated by air jacket wall 2720 from cascaded blades 2710 surrounding the core 2840.

The geometric features of hydrocyclone deoiling device 2400 cyclones and the geometry of the cascaded blades 2710 are optimized to achieve the required mean bubble size of 100 microns. Geometric features of hydrocyclone deoiling device 2400 cyclone are shown in cross sections (A-A) Horizontal section through blades showing gas flow (B-B) Vertical section (C-C) Isometric view, (D-D) Horizontal section through blades showing blade orientations.

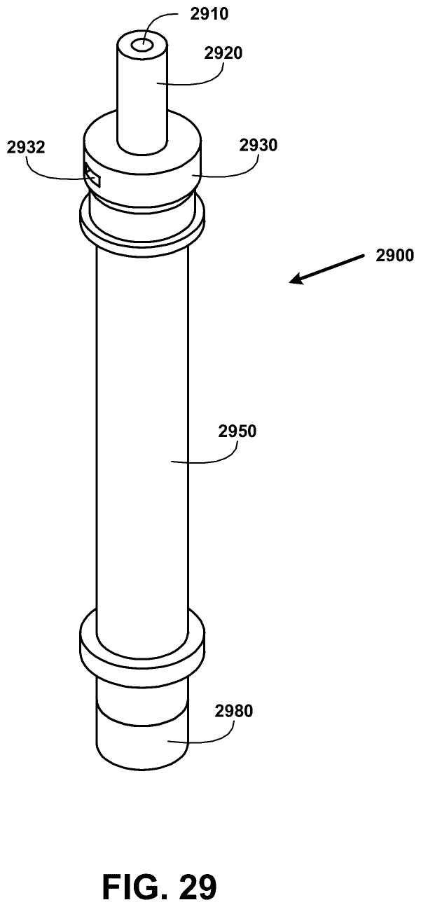

FIG. 29 shows for illustrative purposes only an example of hydrocyclone desalination device prospective view of one embodiment. FIG. 29 shows the hydrocyclone desalination device 2900. The hydrocyclone desalination device 2900 includes an overflow opening 2910 of the overflow pipe 2920. The boiling saltwater is injected at a high velocity through the tangential inlet 2932 of the volute 2930. The boiling saltwater flashes and steam is generated due to the pressure reduction. The steam and water undergoes a phase separation of the saltwater mist and steam. The heavy steam water forms against the hydrocyclone wall 2950. The saltwater mist flows towards the exterior through the underflow exit 2980. The steam creates a steam core that is supported by the bottom base and flows through the overflow opening 2910 of the overflow pipe 2920.

The hydrocyclone desalination device 2900 is used for steam flashing and separation in thermal water desalination plants. The configuration of the hydrocyclone desalination device 2900 is made with multi-inlet openings to achieve symmetric swirling velocity inside the cyclone. The hot saturated saltwater is heated up to reach the boiling temperature that corresponds to a certain operating pressure. The heated water enters the cyclone through multi-inlet openings. The inlet openings are optimized to produce a certain pressure drop and produce a mixture of steam and mist.

The maximum pressure occurs at the peripheral wall of the hydrocyclone, and the minimum pressure occurs at the core along the centerline. This pressure drops through the inlet opening determines the throughput of the cyclone. The mixture of steam and water enters the cyclone in a tangential direction that forces the mixture to swirl inside the cyclone at high velocity. The swirling mixture of water and steam produces large centrifugal acceleration that results in a phase separation of the saltwater mist and steam. The heavy phase of water creates a strong swirling layer near the cyclone wall while the steam (lighter phase) creates a steam core inside the cyclone. The design of overflow pipe and underflow opening play a role in the separation process of steam and water. The diameter of the cyclone, the inner radius of underflow, and the height of the overflow pipe are important parameters to optimize separation efficiency. These two parameters have been optimized using computational fluid dynamics to achieve nearly 100% separation efficiency of water and steam.

The inner diameter of the overflow pipe is a parameter as well to allow for only steam to exit the cyclone. This diameter depends on the diameter of the cyclone. The overflow pipe to the diameter of the cyclone ratio can be in the range of 0.3-0.4 to achieve efficient separation of steam from the mist of saltwater. The steam exits from the overflow pipe while the water exits from the bottom annular underflow openings. The geometry of the underflow openings is a set of annular slots near the cyclone wall to allow for a swirling layer of saltwater only to exit from the underflow. The outer diameter of the annular slots is equal to the cyclone diameter and the inner diameter of the slots is nearly equal to 0.85-0.9 of the cyclone diameter. This ratio is used to control the thickness of the swirling layer of water such that the underflow slots are 100% full of water while steam remains in the core of the cyclone. The radial thickness of the underflow is nearly equal to the thickness of the swirling layer of saltwater such that no steam will escape through the underflow exit and flow only through the overflow exit. The optimum inner depth of the overflow pipe 3152 is between 3-5 times the inner diameter of the cyclone.

The operation can be described as follows. The saturated saltwater (water at boiling temperature) enters the cyclone at a certain flow rate. The pressure will drop by a certain value that is corresponding to the flow rate of the saltwater in the inlet converging nozzle of the cyclone. The stream of saltwater will be accelerated through the inlet nozzle and produce a mixture of steam and mist of saltwater. The mixture of steam and mist will swirl at high velocity in the range of 5-10 m/s. The mist will accumulate at the wall and create a layer of swirling saltwater while steam will reside in the core of the cyclone. The steam will separate and exit from the overflow pipe while the saltwater will exit from the underflow opening of one embodiment.

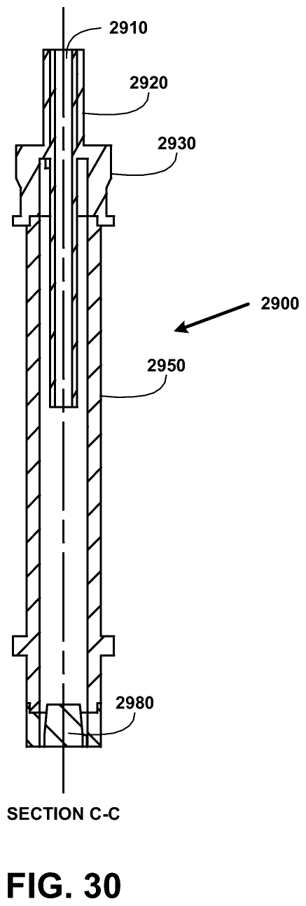

FIG. 30 shows for illustrative purposes only an example of hydrocyclone desalination device cross section C-C of one embodiment. FIG. 30 shows cross section C-C of the hydrocyclone desalination device 2900 having an overflow pipe 2920. One of the two steam and water inlets is where steam and water enters the cyclone in a volute 2910. The hydrocyclone contains air/gas base 2980 that supports the steam core and prevent steam from flowing outward through the underflow; (i.e. steam only flows from the overflow 2920 and saltwater flows outward only through the underflow 2980.

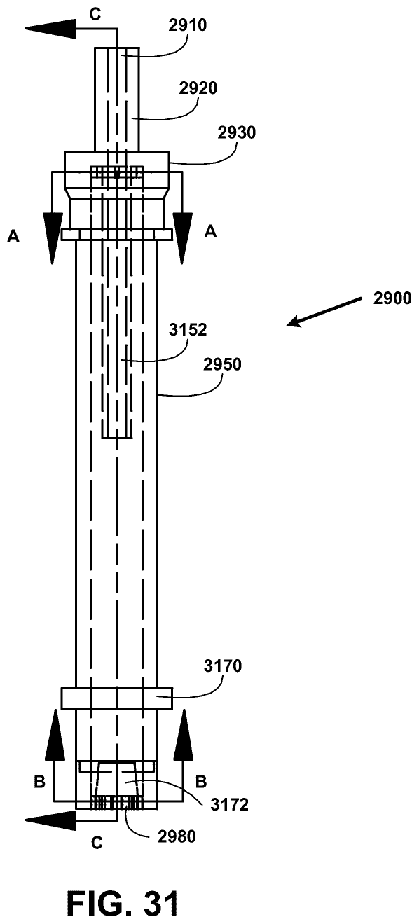

FIG. 31 shows for illustrative purposes only an example of hydrocyclone desalination device cross section lines A, B, and C of one embodiment. FIG. 31 shows the hydrocyclone desalination device 2900 indicating the section lines A, B, and C. FIG. 31 shows a steam and water inlet 2910, steam and water inlet pipe 2920, and hydrocyclone wall 2950. Further showing air/gas base 2980 that supports the steam core and prevent steam from flowing outward through the underflow; (i.e. steam only flows from the overflow 2920 and saltwater flows outward only through the underflow 2980.

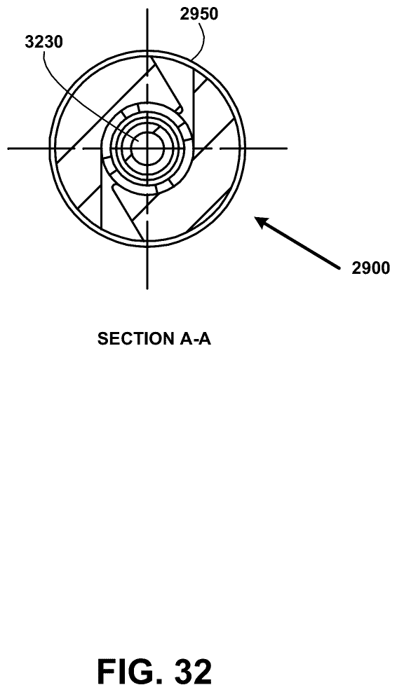

FIG. 32 shows for illustrative purposes only an example of hydrocyclone desalination device cross section A-A of one embodiment. FIG. 32 shows the hydrocyclone desalination device 2900 having the hydrocyclone two symmetric inlets 2932 where saturated water flows into the cyclone. Steam accumulates and flows out the overflow pipe 2920 of FIG. 29 and overflow opening 2910 of FIG. 29. The saltwater mist flows downward from the core 3230 to the exterior of the hydrocyclone desalination device 2900 through the underflow exit openings 2980 of FIG. 29.

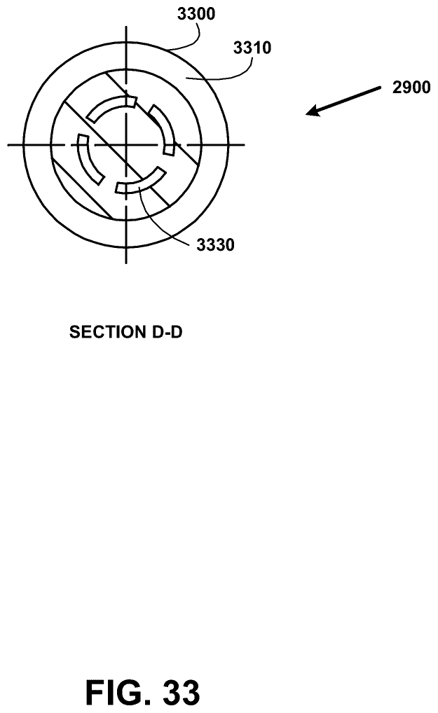

FIG. 33 shows for illustrative purposes only an example of hydrocyclone desalination device cross section D-D of one embodiment. FIG. 33 shows a hydrocyclone desalination device 2900 view through inlet openings. The view shows an underflow tube 3310 creating the underflow 3300 and the underflow exit openings 3330. No steam will escape through underflow exit openings 3330 because of the air/gas base at the bottom of the cyclone.

Although the apparatus(es) and/or method(s) of this disclosure have been described in detail for the purpose of illustration based on what is currently considered to be the most practical and preferred implementations, it is to be understood that such detail is solely for that purpose and that the disclosure is not limited to the disclosed implementations, but, on the contrary, is intended to cover modifications and equivalent arrangements that are within the spirit and scope of the appended claims. For example, it is to be understood that the present disclosure contemplates that, to the extent possible, one or more features of any implementation can be combined with one or more features of any other implementation.

The foregoing has described the principles, embodiments, and modes of operation of the present invention. However, the invention should not be construed as being limited to the particular embodiments discussed. The above-described embodiments should be regarded as illustrative rather than restrictive, and it should be appreciated that variations may be made in those embodiments by workers skilled in the art without departing from the scope of the present invention as defined by the following claims.

What is claimed is:

1. A hydrocyclone apparatus for separating particles from a slurry, comprising:
a central body wall extending from a first opening at one end to a second opening at the opposite end;
an air base column coupled to the second opening configured to support the air/gas core inside hydrocyclone;
at least one slurry from a group of containing water with solid particles, hydrophobic particles, or saltwater particles configured to be flowed into the hydrocyclone apparatus;
a first volute coupled to the first opening slurry input port configured to allow slurry to flow from the volute into the central body;
an overflow opening coupled to the first opening configured to recover separated water and hydrophobic particles;
a second volute coupled to the second opening exhaust port configured to allow slurry to exit the central body; and
a plurality of underflow exit openings coupled to the exhaust port that expel particles from the apparatus.

2. The hydrocyclone apparatus configured to separate particles from a slurry of claim 1, wherein the first volute includes an overflow port that is positioned along the longitudinal axis of the central body, the overflow port is configured to receive froth and/or concentrates outputted from the interior of the central body by the hydrocyclone through the first cyclonic opening and to output the froth and/or concentrates from the apparatus.

3. The hydrocyclone apparatus configured to separate particles from a slurry of claim 2, wherein the body interface of the first volute includes an attachment opening opposite from the overflow port on the longitudinal axis of the central body, the attachment opening has a generally circular shape and is surrounded by an annular plate.

4. The hydrocyclone apparatus configured to separate particles from a slurry of claim 3, wherein the annular plate of the first volute includes holes, wherein the holes are configured to house a mechanism to attach the first volute to the first body opening of the central body.

5. The hydrocyclone apparatus configured to separate particles from a slurry of claim 1, wherein the hydrophobic particles include oil droplets in bubble-droplet aggregates configured to flow upward with water and exit through the top overflow opening of the cyclone into the flotation tank.

6. The hydrocyclone apparatus configured to separate particles from a slurry of claim 1, wherein the overflow opening coupled to the first volute configured to output froth and concentrates from the hydrocyclone formed in the interior of the central body and outputting the froth and/or concentrates to the exterior of the central body.

7. The hydrocyclone apparatus configured to separate particles from a slurry of claim 1, further comprising the second slurry hydrophobic particles include oil droplets wherein the oil droplets colliding with micro-bubbles of 100 microns create stable bubble-droplet aggregates that exit from the top overflow pipe into a shallow flotation tank for skimming to recover the oil.

8. A hydrocyclone apparatus for separating particles from a slurry, comprising:
a central body wall extending from a first opening at one end to a second opening at the opposite end;
an air base column coupled to the second opening configured to support the hydrocyclone;
at least one slurry from a group of containing water with solid particles, hydrophobic particles, or saltwater particles configured to be flowed into the hydrocyclone apparatus;
a first volute coupled to the first opening slurry input port configured to allow slurry to flow from the volute into the central body;
an overflow opening coupled to the first opening configured to recover separated water and hydrophobic particles;
a second volute coupled to the second opening exhaust port configured to allow slurry to exit the central body;
an underflow component coupled to the second opening configured to allow for a continuous separation of sand from a wellhead upstream water without the need to stop the production; and
a plurality of underflow exit openings coupled to the exhaust port that expel particles from the apparatus without clogging where the water split ratio is controlled.

9. The hydrocyclone apparatus configured to separate particles from a slurry of claim 8, wherein the body interface of the second volute includes an attachment opening opposite from the exhaust opening on the longitudinal axis of the central body, the attachment opening has a generally circular shape and is surrounded by an annular plate.

10. The hydrocyclone apparatus configured to separate particles from a slurry of claim 9, wherein the annular plate of the second volute includes holes, wherein the holes are configured to house a mechanism to attach the second volute to second body opening of the central body.

11. The hydrocyclone apparatus configured to separate particles from a slurry of claim, wherein the first volute includes an overflow port that is positioned along the longitudinal axis of the central body, the overflow port is configured to receive froth and/or concentrates outputted from the interior of the central body by the hydrocyclone through the first cyclonic opening and to output the froth and/or concentrates from the apparatus.

12. The hydrocyclone apparatus configured to separate particles from a slurry of claim 8, wherein the body interface of the first volute includes an attachment opening opposite from an overflow port on the longitudinal axis of the central body, the attachment opening has a generally circular shape and is surrounded by an annular plate.

13. The hydrocyclone apparatus configured to separate particles from a slurry of claim 8, wherein the annular plate of the first volute includes holes, wherein the holes are configured to house a mechanism to attach the first volute to the first body opening of the central body.

14. The hydrocyclone apparatus configured to separate particles from a slurry of claim 8, wherein the hydrophobic particles include oil droplets in bubble-droplet aggregates with bubbles configured to flow upward with water and exit through the top overflow opening of the cyclone into the flotation tank.

15. The hydrocyclone apparatus configured to separate particles from a slurry of claim 1, wherein the overflow opening coupled to the first volute configured to output froth and concentrates from the hydrocyclone formed in the interior of the central body and outputting the froth and/or concentrates to the exterior of the central body.

16. A method for separating particles from a slurry, the method comprising:
flowing slurry, via a slurry input port, into a first volute;
providing fluid communication of slurry, via a first cyclonic opening, between the first volute and an interior of a central body to be separated by a hydrocyclone formed therein, a central air column being formed within the core of the hydrocyclone the central body being formed of a body wall that runs longitudinally from a first body opening at one end to a second body opening at another end opposite the first body opening, the first cyclonic opening being formed by a body interface of the first volute being connected to the first body opening of the central body;
providing fluid communication, via a second cyclonic opening, between the interior of the central body and a second volute, the second cyclonic opening being formed by a body interface of the second volute connected to the second body opening of the central body;
receiving, via an exhaust opening of the second volute, exhausted slurry from the interior of the central body, the exhaust opening formed by the base surface and an interior wall of the second volute, the exhaust opening is generally annular in shape; providing, via an exhaust port of the second volute, fluid communication of exhausted slurry from the exhaust opening to the exterior of the apparatus; and
retaining, via an air base column, air to support the hydrocyclone formed within the interior of the central body, the air base column forming a base surface at the second cyclonic opening, wherein the air base column has a diameter similar to a diameter of the central air column of the hydrocyclone so that during operation of the hydrocyclone slurry flows from the interior of the central body to the exhaust opening to be expelled from the apparatus via the exhaust port.

17. The method of claim 15, wherein method further comprises: receiving, via an overflow port, outputted froth and/or concentrates from the hydrocyclone formed in the interior of the central body and outputting the froth and/or concentrates to the exterior of the central body, the overflow port is positioned along the longitudinal axis of the central body on the first volute.

18. The method of claim 16, wherein the body interface of the first volute includes an attachment opening opposite from the overflow port on the longitudinal axis of the central body, the attachment opening has a generally circular shape and is surrounded by an annular plate.

19. The method of claim 15, wherein providing a slurry includes a first slurry comprised of water with suspended solid particles.

20. The method of claim 15, wherein providing a slurry includes a second slurry comprised of water with hydrophobic particles including oil droplets.
